(19) United States
(12) Patent Application Publication
(10) Pub. No.: US 2026/0269542 A1
(43) Pub. Date: Sep. 10, 2026

(54) CONNECTOR

(71) Applicant: LS MTRON LTD., Anyang-si, Gyeonggi-do (KR)

(72) Inventors: Jung Hoon CHOI, Anyang-si, Gyeonggi-do (KR); Hyun Woo LEE, Anyang-si, Gyeonggi-do (KR); Hyun Joo HWANG, Anyang-si, Gyeonggi-do (KR); Dong Wan KIM, Anyang-si, Gyeonggi-do (KR)

(21) Appl. No.: 19/166,137

(22) PCT Filed: Jun. 19, 2024
(86) PCT No.: PCT/KR2024/008442

§ 371 Date: Sep. 17, 2025

(30) Foreign Application Priority Data
Jun. 29, 2023 (KR) 10-2023-0084140
Jun. 17, 2024 (KR) 10-2024-0078013

(51) Int. Cl. H01R 13/6597; H01R 12/71

(52) U.S. Cl. CPC H01R 13/6597; H01R 12/716

(57) ABSTRACT

Disclosed is a connector. A connector, according to an aspect of the present disclosure, comprises: an insulating body including three straight line type island parts; a shield member coupled along the edge of the insulating body; and a contact part coupled to the insulating body to be electrically connected to the outside, wherein a shield contact may be arranged to surround the top surface, the front surface, and the side surface of a second island part and the top surface, the front surface, and the side surface of a third island part among the three straight line type island parts while surrounding the end portion of an RF contact, or arranged to surround the top surface, the rear surface, and the side surface of the second island part and the top surface, the rear surface, and the side surface of the third island part while surrounding the end portion of the RF contact.

### CROSS-REFERENCE TO RELATED APPLICATIONS

This application is the National Stage filing under 35 U.S.C. 371 of International Application No. PCT/KR2024/008442, filed on Jun. 19, 2024, which claims the benefit of earlier filing date and right of priority to Korean Application No. 10-2023-0084140, filed Jun. 29, 2023, and Korean Application No. 10-2024-0078013, filed Jun. 17, 2024, the contents of which are all hereby incorporated by reference herein in their entirety.

### FIELD

The present disclosure relates to a connector.

### BACKGROUND

A board-to-board (B2B) connector is used for internal connections between a substrate and a module, with a corresponding receptacle connector and plug connector coupled to each other.

Each of the receptacle connector and the plug connector is connected to different substrates, and when they are physically coupled, the different substrates are electrically connected to each other, allowing for signal transmission.

That is, each of the receptacle connector and the plug connector includes multiple contacts for transmitting various signals, and when the corresponding contacts make contact with each other, they become electrically connected, allowing for signal transmission.

However, when the plug connector and the receptacle connector are physically coupled to electrically connect the contacts of the plug connector and the receptacle connector, there is a risk that each contact may be damaged due to the pressure generated during the coupling process.

Therefore, a method is needed to facilitate coupling between the receptacle connector and the plug connector, while reinforcing and improving its strength.

### SUMMARY

The present disclosure has been made to address the above problems, and an object of the present disclosure is to provide a connector capable of reinforcing its strength while allowing corresponding contacts to form multiple contact points.

In addition, the present disclosure aims to provide a connector capable of improving RF signal transmission performance by optimizing contact point positions of corresponding shield contacts.

The problems of the present disclosure are not limited to those mentioned above, and other problems not mentioned will be clearly understood by those of ordinary skill in the art from the following description.

According to an aspect of the present disclosure, there is provided a connector including: an insulating body having three bar-shaped islands, each configured to have a predetermined length along a first axis direction as a longitudinal direction and to protrude from a bottom at a predetermined height, the three bar-shaped islands being spaced apart from one another along a second axis direction perpendicular to the first axis; a shield configured to be made of a conductive material, and coupled along a rim of the insulating body; and a contact configured to be coupled to the insulating body to be electrically connected to an outside, wherein the three bar-shaped islands include a first island, and a second island and a third island disposed on both sides of the first island along the second axis direction as a width direction, wherein the contact includes an RF contact for transmitting an RF signal, a signal contact for transmitting a general signal, and a shield contact for electrical shielding, and wherein the RF contact is disposed to be positioned between the second island and the third island facing each other, and wherein the shield contact is disposed to surround an end of the RF contact and to cover an upper surface, a front surface, and a side surface of the second island and an upper surface, a front surface, and a side surface of the third island, or is disposed to surround an end of the RF contact and to cover an upper surface, a rear surface, and a side surface of the second island and an upper surface, a rear surface, and a side surface of the third island.

According to another aspect of the present disclosure, there is provided a connector including: an insulating body having three bar-shaped islands, each configured to have a predetermined length along a first axis direction as a longitudinal direction and to protrude from a bottom at a predetermined height, the three bar-shaped islands being spaced apart from one another along a second axis direction perpendicular to the first axis; a shield configured to be made of a conductive material, and coupled to a rim area along a rim of the insulating body; and a contact configured to be coupled to the insulating body to be electrically connected to an outside, wherein the three bar-shaped islands include a first island, and a second island and a third island disposed on both sides of the first island along the second axis direction as a width direction, wherein the contact includes an RF contact for transmitting an RF signal, a signal contact for transmitting a general signal, and a shield contact for electrical shielding, wherein the first island is configured to have a relatively shorter length than the second island and the third island along the first axis direction so as to be disposed at one end side of the first island while the RF contact is disposed between a side surface of the second island and a side surface of the third island facing each other.

According to the configuration described above, the connector according to the present disclosure enhances contact stability through multiple contact points while reinforcing its strength, thereby reducing the possibility of damage due to contact when coupled with a counterpart.

In addition, the connector according to the present disclosure improves RF signal shielding performance by arranging the contact point positions of the shield contacts to surround the RF contacts, thereby enhancing RF signal transmission performance.

Advantageous effects of the present disclosure are not limited to the above-described effects, and should be understood to include all effects that can be inferred from the configuration of the invention described in the detailed description or claims of the present disclosure.

### BRIEF DESCRIPTION OF THE DRAWINGS

FIG. 1 is a view illustrating the connector and the corresponding connector according to an embodiment of the present disclosure in a separated state.

FIG. 2 is a view illustrating the connector according to an embodiment of the present disclosure.

FIG. 3 is a view of FIG. 2 as seen from the bottom.

FIG. 4 is a view illustrating the connector of FIG. 2 with an insulating body, a shield, and a contact separated.

FIG. 5 is a view of FIG. 4 as seen from the bottom.

FIG. 6 is a plan view of FIG. 2.

FIG. 7 is a view illustrating only the contact from FIG. 4.

FIG. 8 is a view illustrating only the RF contact from FIG. 7.

FIG. 9 is a view illustrating only the first section of the shield contact from FIG. 7.

FIG. 10 is a view illustrating only the second and third sections of the shield contact from FIG. 7.

FIG. 11 is a view illustrating the connector cut along a direction A-A of FIG. 6.

FIG. 12 is a view illustrating the connector cut along a direction B-B of FIG. 6.

FIG. 13 is a view illustrating the connector cut along a direction C-C of FIG. 6.

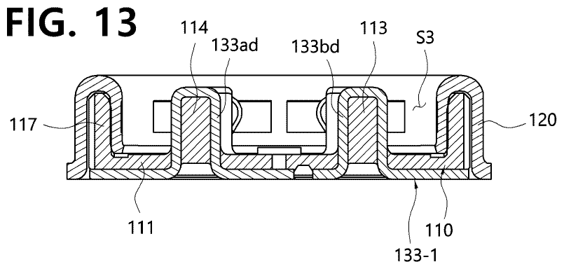

FIG. 14 is a view illustrating the connector cut along a direction D-D of FIG. 6.

FIG. 15 is a view illustrating a corresponding connector according to an embodiment of the present disclosure.

FIG. 16 is a view of FIG. 15 as seen from the bottom.

FIG. 17 is a view illustrating the corresponding connector of FIG. 15 with an insulating body, a shield, and a contact separated.

FIG. 18 is a view of FIG. 17 as seen from the bottom.

FIG. 19 is a plan view of FIG. 15.

FIG. 20 is a view illustrating only the contact from FIG. 17.

FIG. 21 is a view illustrating only the shield contact from FIG. 20.

FIG. 22 is a view illustrating the connector cut along a direction E-E of FIG. 19.

FIG. 23 is a view illustrating the connector cut along a direction F-F of FIG. 19.

FIG. 24 is a view illustrating the connector cut along a direction G-G of FIG. 19.

FIG. 25 is a view illustrating the connector cut along a direction H-H of FIG. 19.

FIG. 26 is a view illustrating the connector of FIG. 11 and the connector of FIG. 22 in a coupled state.

FIG. 27 is a view illustrating the connector of FIG. 12 and the connector of FIG. 23 in a coupled state.

FIG. 28 is a view illustrating the connector of FIG. 13 and the connector of FIG. 24 in a coupled state.

FIG. 29 is a view illustrating the connector of FIG. 14 and the connector of FIG. 25 in a coupled state.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

The words and terms used in the present specification and claims should not be interpreted as being limited to their ordinary or dictionary meanings, but should be construed as having meanings and concepts consistent with the technical spirit of the present disclosure, in accordance with the principle that an inventor may define terms and concepts to best describe their invention.

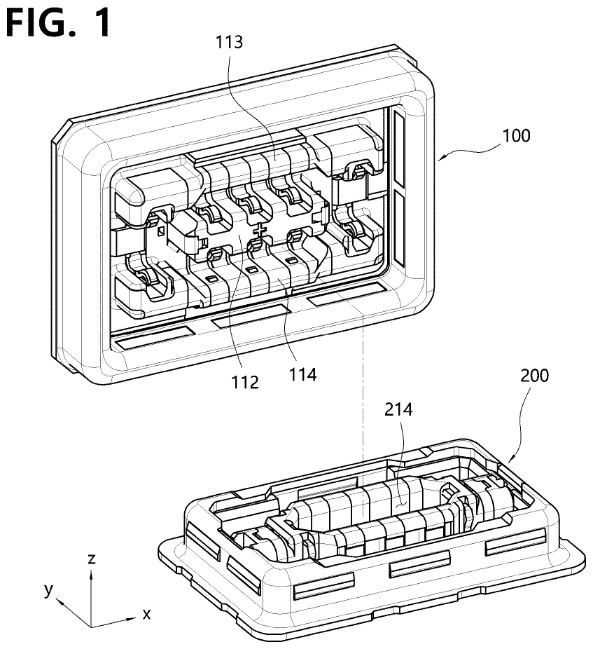

In addition, a first axial direction used in the specification and the claims may refer to a direction parallel to the x-axis in FIGS. 1, 2, and 15, a second axial direction may refer to a direction parallel to the y-axis in FIGS. 1, 2, and 15, and a third axial direction may refer to a direction parallel to the z-axis in FIGS. 1, 2, and 15.

Moreover, a longitudinal direction used in the specification and the claims may refer to a direction parallel to the first axial direction or the x-axis, a width direction may refer to a direction parallel to the second axial direction or the y-axis, and a thickness direction and a height direction may refer to a direction parallel to the third axial direction or the z-axis.

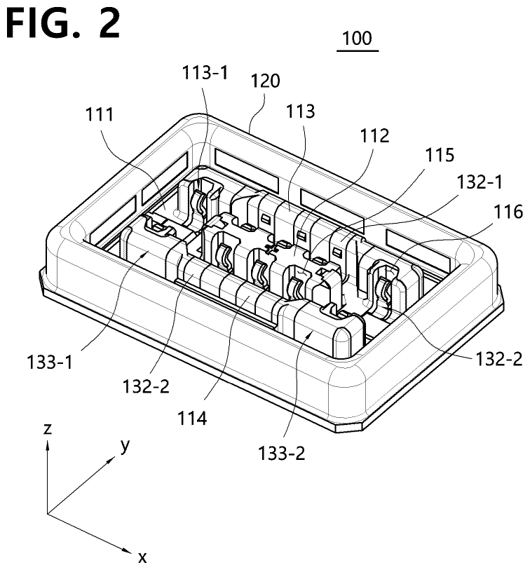

Additionally, a front surface used in the specification and the claims may refer to a surface perpendicular to the first axial direction or the x-axis, located on the left side of both ends of the first island with respect to FIG. 2, and a rear surface may refer to a surface perpendicular to the first axial direction or the x-axis, located on the right side of both ends of the first island with respect to FIG. 2.

The connector 100 according to an embodiment of the present disclosure may be a board-to-board (B2B) connector configured to electrically connect two different substrates.

That is, the connector 100 according to an embodiment of the present disclosure may be mechanically engaged with the corresponding connector 200 as illustrated in FIG. 1, and when engaged, may electrically connect two different substrates.

In such a case, the connector 100 may be mounted on one of the module substrates (not illustrated), and the corresponding connector 200 may be mounted on the other module substrate (not illustrated).

Accordingly, when the connector 100 and the corresponding connector 200 are physically coupled with each other, the module substrate on which the connector 100 is mounted and the module substrate on which the corresponding connector 200 is mounted may be electrically connected to each other.

In the present disclosure, at least a portion of the connector 100 and the corresponding connector 200 may be provided in shapes corresponding to each other so as to be physically coupled with each other, and each of the connector 100 and the corresponding connector 200 may be configured to simultaneously transmit a radio frequency (RF) signal and a general signal.

In addition, the connector 100 may be a receptacle connector, and the corresponding connector 200 may be a plug connector.

However, the present disclosure is not limited thereto, and the connector 100 may be a plug connector, and the corresponding connector 200 may be a receptacle connector.

In this case, when the connector 100 according to an embodiment of the present disclosure is physically coupled with the corresponding connector 200, contacts corresponding to each other may form multiple contact points.

In addition, the connector 100 according to an embodiment of the present disclosure may be configured to reduce the possibility of damage due to contact when coupled with the corresponding connector 200.

That is, the connector 100 according to an embodiment of the present disclosure may secure contact stability through a multi-contact structure of contacts corresponding to each other, while reducing the possibility of damage due to physical contact when coupled with the corresponding connector 200.

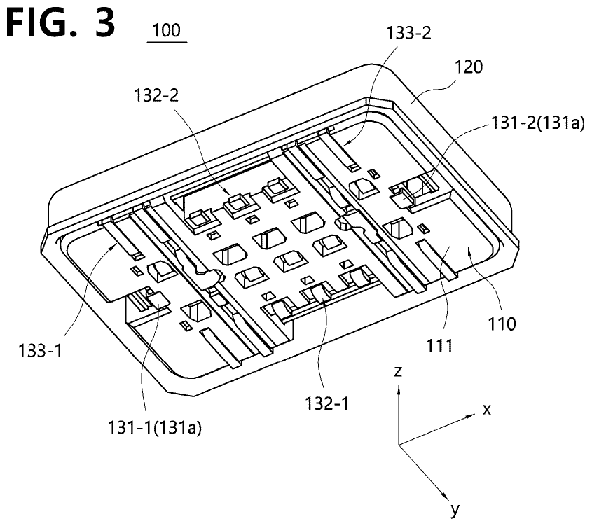

For this purpose, the connector 100 according to an embodiment of the present disclosure may include a receptacle insulating body 110, a shield 120, and a contact 130, as illustrated in FIGS. 2 to 6.

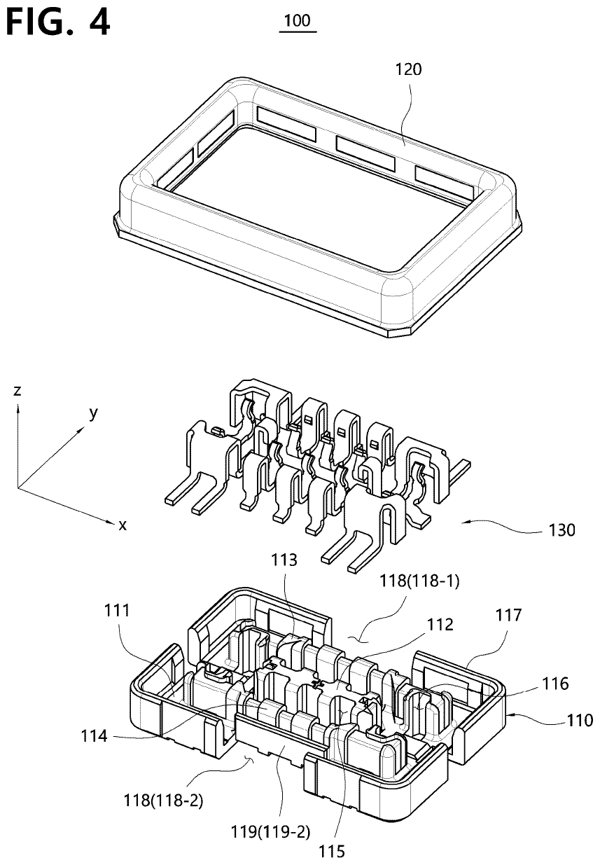

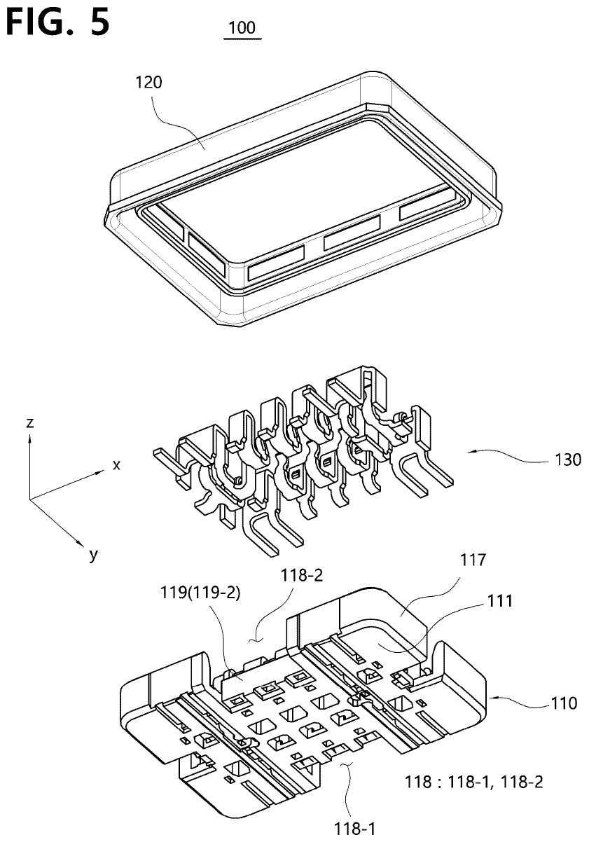

The insulating body 110 may be made of an electrically insulating material and may define the overall outer shape of the connector 100. For example, the insulating body 110 may have a substantially rectangular parallelepiped shape, as illustrated in FIGS. 4 and 5.

In this case, the insulating body 110 may be configured such that contacts corresponding to each other form multiple contact points when the connector 100 is coupled with the corresponding connector 200, as described above.

For this purpose, the insulating body 110 may include a plate-shaped bottom 111 having a predetermined area, and three bar-shaped islands 112, 113, and 114 that are configured to have a predetermined length along a first axis direction as a longitudinal direction and protrude from the bottom 111 at a predetermined height.

That is, the insulating body 110 may include three bar-shaped islands 112, 113, and 114 formed along a first axis direction as a longitudinal direction, the three bar-shaped islands 112, 113, and 114 may be spaced apart from one another along a second axis direction perpendicular to the first axis, and a plurality of accommodating spaces S1, S2, and S3 may be formed in the insulating body 110 through the three bar-shaped islands.

For example, the insulating body 110 may include a first island 112, a second island 113, and a third island 114 that are configured to have a predetermined length along a first axis direction as a longitudinal direction and to be spaced apart by a predetermined distance along a second axis direction as a width direction, as illustrated in FIGS. 4 to 6, and three accommodating spaces S1, S2, and S3 may be formed through the first island 112, the second island 113, and the third island 114.

In such a case, the first island 112 may be disposed at a central portion, and the second island 113 and the third island 114 may be spaced apart from the first island 112 on both sides thereof along the second axis direction such that one surface of each face the first island 112, and the first island 112, the second island 113, and the third island 114 may protrude from the bottom 111 at a predetermined height.

Accordingly, a first accommodating space S1 may be formed between the first island 112 and the second island 113, a second accommodating space S2 may be formed between the first island 112 and the third island 114, and a third accommodating space S3 may be formed to surround the first island 112, the second island 113, and the third island 114.

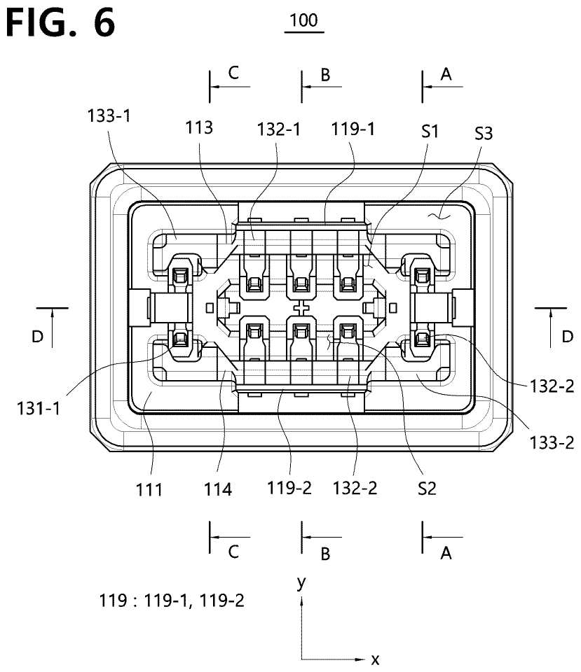

That is, as illustrated in FIG. 6, the first accommodating space SI and the second accommodating space S2 may be formed to be positioned on both sides of the first island 112, and the insulating body 110 may be configured such that, in the width direction, the third island 114, the second accommodating space S2, the first island 112, the first accommodating space S1, and the second island 113 are sequentially arranged.

In such a case, the insulating body 110 may include a rim area 117 that extends from the edge of the bottom 111 to a predetermined height so as to surround the first, second, and third islands 112, 113, and 114, and the third accommodating space S3 may be formed to be positioned between the second island 113, the third island 114, and the rim area 117.

Here, the first accommodating space S1 and the second accommodating space S2 may accommodate a ring-shaped island 212 of the corresponding connector 200 to be described later, and the contact 130 may form multiple contact points with a contact 230 of the corresponding connector 200 when the ring-shaped island 212 is inserted into the first and second accommodating spaces. This will be described later in detail.

In this case, the first island 112 may be configured to have a relatively shorter length than the second island 113 and the third island 114, and may be arranged such that both ends of the first island 112 are positioned near the middle of the lengths of the second and third islands 113 and 114, respectively.

Accordingly, at one end of the first island 112, an arrangement space may be formed, the space being defined by a side surface of the second island 113, a side surface of the third island 114, and a front surface of the first island 112 facing each other, and at the other end of the first island 112, another arrangement space may be formed, the space being defined by a side surface of the second island 113, a side surface of the third island 114, and a rear surface of the first island 112 facing each other.

Through this, some of the contacts 130 may be arranged to be positioned in the mounting space. For example, an RF contact 131 among the contacts 130 may be arranged to be positioned in the mounting space.

The shield 120 may serve to shield electromagnetic waves introduced from the outside while preventing damage to the insulating body 110 caused by excessive pressure when coupled with the corresponding connector 200.

In addition, the shield 120 may serve to shield electromagnetic waves generated from the contact 130 coupled to the insulating body 110.

For this purpose, the shield 120 may be made of a metal material, but is not limited thereto, and any known material may be used as long as it has a predetermined strength and electrical conductivity.

As illustrated in FIGS. 2 to 6, the shield 120 may be coupled to the insulating body 110 to surround the entire edge of the insulating body 110.

That is, the shield 120 may be coupled to the rim area 117 extending to a predetermined height from the bottom 111, and when coupled to the rim area 117, the shield 120 may be arranged to surround the entire edge of the insulating body 110.

Through this, when the connector 100 according to an embodiment of the present disclosure is coupled with the corresponding connector 200, the shield 120 may be brought into contact with the shield 220 of the corresponding connector 200 and may be electrically connected to form a ground together with a shield contact 133 to be described later.

The contact 130 may be coupled to the insulating body 110 and may be electrically connected to the outside.

For this purpose, the contact 130 may be made of a conductive material such as a metal and may be coupled to the insulating body 110 such that at least a portion of the contact 130 is exposed to the outside.

The contact 130 may include a plurality of contacts for a predetermined function, and the plurality of contacts may be coupled to the insulating body 110 to be in contact with a contact of the corresponding connector 200 or a substrate.

For example, as described above, the contact 130 may be provided in the insulating body 110 to surround the surfaces of the three bar-shaped islands 112, 113, and 114 that protrude from the bottom 111 at a predetermined height and to be exposed to the outside.

Here, the contact 130 may be detachably coupled to the insulating body 110, or may be integrally formed with the insulating body 110 through insert molding.

Accordingly, the contact 130 may form an electrical contact with a contact 230 of the corresponding connector 200 when coupled with the corresponding connector 200.

In this case, as described above, the contact 130 may be configured to simultaneously transmit a radio frequency (RF) signal and a general signal, and may be provided in the insulating body 110 to form multiple contact points with the contact 230 of the corresponding connector 200.

For example, the contact 130 may include an RF contact 131 for transmitting an RF signal, a signal contact 132 for transmitting a general signal, and a shield contact 133 for electrical shielding, and each of the RF contact 131, the signal contact 132, and the shield contact 133 may be provided in the insulating body 110 to form multiple contact points with the contact 230 of the corresponding connector 200, respectively.

In addition, each of the RF contact 131, the signal contact 132, and the shield contact 133 may be provided in a plurality spaced apart from one another along the first axis direction.

In such a case, the RF contact 131 and the shield contact 133 may be provided in the insulating body 110 to form multiple contact points in the mounting space, and the signal contact 132 may be provided in the insulating body 110 to form multiple contact points within the first accommodating space S1 or the second accommodating space S2.

As a specific example, as illustrated in FIGS. 2 to 7, the RF contact 131 may include a first RF contact 131-1 and a second RF contact 131-2 spaced apart from each other along the first axis direction.

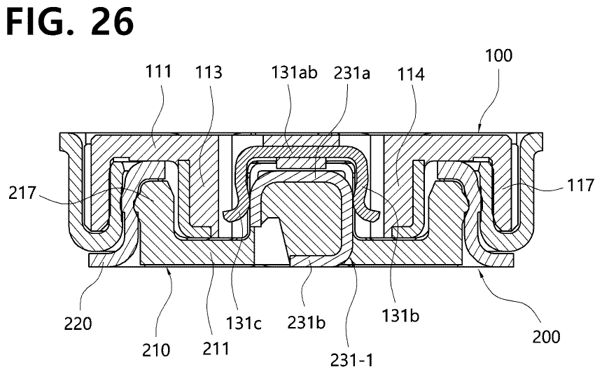

In such a case, when coupled with the corresponding connector 200, as illustrated in FIG. 26, the RF contacts 131 may be provided in the insulating body 110 to surround connection islands 213 inserted into the mounting space and to be brought into contact with the RF contacts 231 provided in the connection island 213 at two locations, respectively.

In addition, the RF contact 131 may be disposed between the second island 113 and the third island 114 that face each other, and may be positioned outside the first island 112 to be spaced apart from a front surface or a rear surface of the first island 112 by a predetermined distance, and may also be disposed in a mounting space defined by side surfaces of the second and third islands 113 and 114 and a front surface or a rear surface of the first island 112.

That is, the first RF contact 131-1 may be disposed outside the first island 112 to be spaced apart from the front surface of the first island 112 by a predetermined distance along the first axis direction and to be located in the mounting space, and the second RF contact 131-2 may be disposed outside the first island 112 to be spaced apart from the rear surface of the first island 112 by a predetermined distance along the first axis direction and to be located in the mounting space.

Here, the first RF contact 131-1 may be disposed between a virtual straight line connecting a front surface of the second island 113 and a front surface of the third island 114, and the front surface of the first island 112, and the second RF contact 131-2 may be disposed between a virtual straight line connecting a rear surface of the second island 113 and a rear surface of the third island 114, and the rear surface of the first island 112.

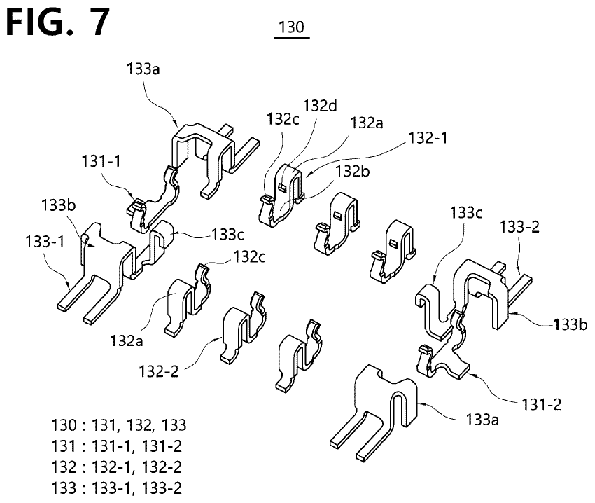

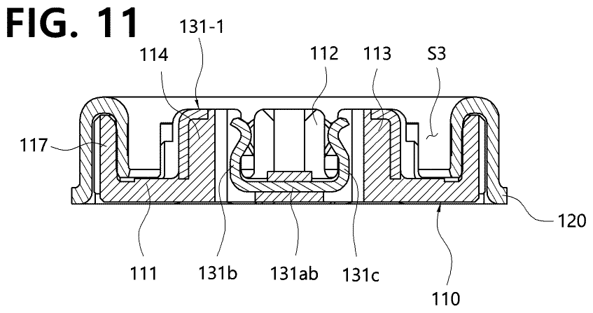

For this purpose, as illustrated in FIGS. 7, 8, and 11, the first RF contact 131-1 may include a buried section 131a embedded in the bottom 111 while being spaced apart from the front surface of the first island 112 by a predetermined distance along the first axis direction, a first movable section 131b extending from one end of the buried section 131a to allow elastic deformation by an external force, and a second movable section 131c extending from the other end of the buried section 131a to allow elastic deformation by the external force.

Here, each of the first movable section 131b and the second movable section 131c may extend along a third axis direction orthogonal to both the first and second axis directions, and may be exposed to the outside within the mounting space.

In addition, the insulating body 110 may include a movable space 116 formed in each of the second island 113 and the third island 114 to be recessed along a third axis direction, which is a height direction, and each of the first movable section 131b and the second movable section 131c may be disposed in the movable space 116.

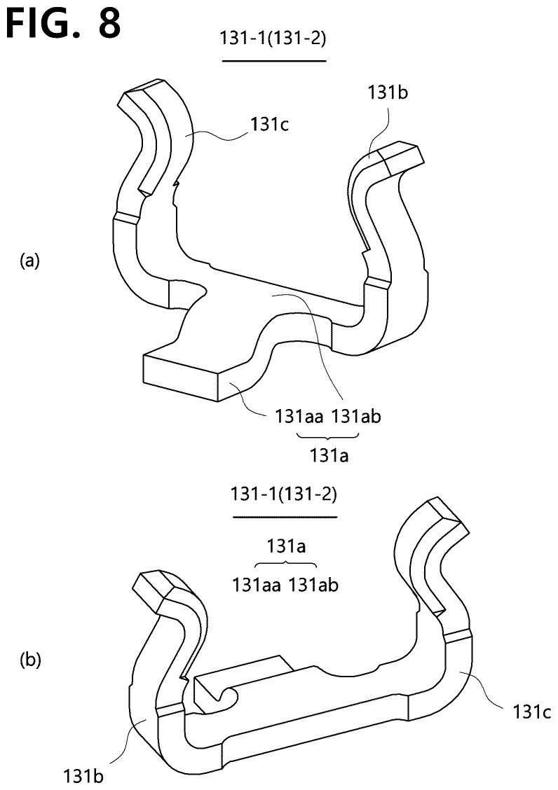

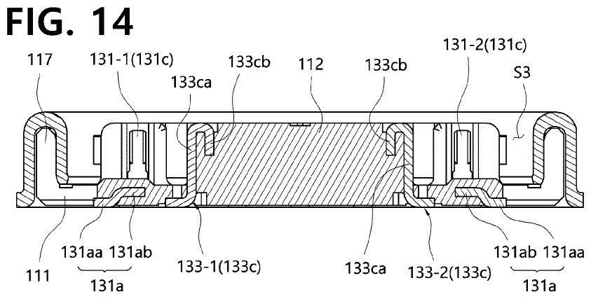

Moreover, as illustrated in FIGS. 8 and 14, the buried section 131a may include a first buried section 131aa that is embedded in the bottom 111 and exposed to the outside through a lower surface of the insulating body 110, and a second buried section 131ab that is also embedded in the bottom 111 and extends from the first buried section 131aa to connect the first buried section 131aa with the first movable section 131b and the second movable section 131c.

Accordingly, the first RF contact 131-1 may be fixed to the insulating body 110 through the buried section 131a, may smoothly form double contact points with the RF contact 231-1 of the corresponding connector 200 through the first movable section 131b and the second movable section 131c, and may be electrically connected to another component, such as a circuit board, through the first buried section 131aa.

Similarly, as illustrated in FIGS. 7, 8, and 11, the second RF contact 131-2 may include a buried section 131a embedded in the bottom 111 while being spaced apart from the rear surface of the first island 112 by a predetermined distance along the first axis direction, a first movable section 131b extending from one end of the buried section 131a to allow elastic deformation by the external force, and a second movable section 131c extending from the other end of the buried section 131a to allow elastic deformation by the external force.

Here, each of the first movable section 131b and the second movable section 131c may extend to a predetermined height along the third axis direction orthogonal to the first and second axis directions, and may be exposed to the outside within the mounting space.

In addition, the insulating body 110 may include a movable space 116 formed in each of the second island 113 and the third island 114 to be recessed along the third axis direction, which is a height direction, and each of the first movable section 131b and the second movable section 131c may be disposed in the movable space 116.

Moreover, as illustrated in FIGS. 8 and 14, the buried section 131a may include a first buried section 131aa that is embedded in the bottom 111 and exposed to the outside through the lower surface of the insulating body 110, and a second buried section 131ab that is also embedded in the bottom 111 and extends from the first buried section 131aa to connect the first buried section 131aa with the first movable section 131b and the second movable section 131c.

Accordingly, the second RF contact 131-2 may be fixed to the insulating body 110 through the buried section 131a, may smoothly form double contact points with the RF contact 231-2 of the corresponding connector 200 through the first movable section 131b and the second movable section 131c, and may be electrically connected to another component, such as a circuit board, through the first buried section 131aa.

As described above, in the connector 100 according to an embodiment of the present disclosure, the RF contact 131 may be provided in a movable structure in which the first movable section 131b and the second movable section 131c, for forming double contact points with the RF contact 231 of the corresponding connector 200, are elastically deformed by the external force, thereby securing enhanced electrical connection stability.

Referring again to FIGS. 2 to 7, the signal contact 132 may include a first signal contact 132-1 and a second signal contact 132-2 spaced apart from each other along the second axis direction.

In such a case, each of the first signal contact 132-1 and the second signal contact 132-2 may be disposed between the first RF contact 131-1 and the second RF contact 131-2 along the first axis direction.

In this case, the first signal contact 132-1 may be fixed to the second island 113 while surrounding its surface and being exposed to the outside, and the second signal contact 132-2 may be fixed to the third island 114 while surrounding its surface and being exposed to the outside.

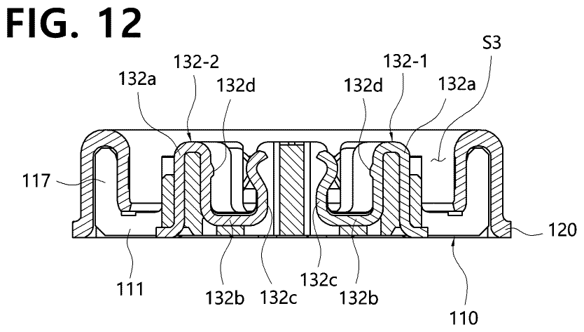

For this purpose, as illustrated in FIGS. 7 and 12, the first signal contact 132-1 may include a fixing section 132a fixed to the second island 113 to surround its surface protruding from the bottom 111 and to be exposed to the outside, a bottom section 132b extending from the fixing section 132a and disposed on a bottom surface of the first accommodating space S1, and a movable section 132c extending from the bottom section 132b to allow elastic deformation by the external force.

Here, the fixing section 132a, the bottom section 132b, and the movable section 132c may all be provided to be exposed to the outside within the first accommodating space S1, and the insulating body 110 may include a movable space 115 recessed into the first island 112 along the third axis direction, which is a height direction, and the movable section 132c may be disposed in the movable space 115.

In such a case, the first signal contact 132-1 may further include a protrusion section 132d that protrudes from the fixing section 132a toward the first accommodating space S1.

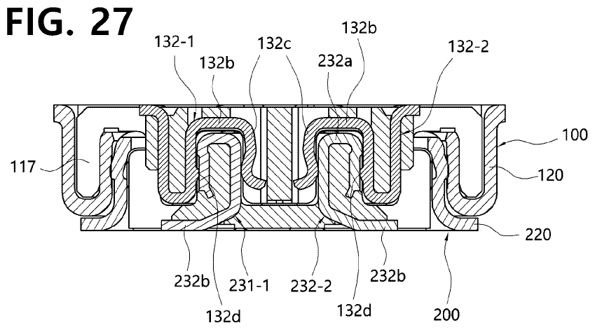

Accordingly, when the connector 100 and the corresponding connector 200 according to an embodiment of the present disclosure are coupled with each other, as illustrated in FIG. 27, the first signal contact 132-1 may form double contact points with the signal contact 232-1 of the corresponding connector 200 through the protrusion section 132d and the movable section 132c within the first accommodating space S1.

Similarly, as illustrated in FIGS. 7 and 12, the second signal contact 132-2 may include a fixing section 132a fixed to the third island 114 to surround its surface protruding from the bottom 111 and to be exposed to the outside, a bottom section 132b extending from the fixing section 132a and disposed on a bottom surface of the second accommodating space S2, and a movable section 132c extending from the bottom section 132b to allow elastic deformation by the external force.

Here, the fixing section 132a, the bottom section 132b, and the movable section 132c may all be provided to be exposed to the outside within the second accommodating space S2, and the insulating body 110 may include a movable space 115 recessed into the first island 112 along the third axis direction, which is the height direction, and the movable section 132c may be disposed in the movable space 115.

In such a case, the second signal contact 132-2 may further include a protrusion section 132d that protrudes from the fixing section 132a toward the second accommodating space S2.

Accordingly, when the connector 100 according to an embodiment of the present disclosure is coupled with the corresponding connector 200, the second signal contact 132-2 may form double contact points with the signal contact 232-2 of the corresponding connector 200 through the protrusion section 132d and the movable section 132c within the second accommodating space S2, as illustrated in FIG. 27.

Through this, the connector 100 according to an embodiment of the present disclosure may form double contact points with the signal contact 232 of the corresponding connector 200 through the protrusion section 132d and the movable section 132c, while the strength of the second and third islands 113 and 114 is reinforced through the fixing section 132a, because the first signal contact 132-1 and the second signal contact 132-2, which are made of a metal material, are fixed to the second or third island 113 or 114 to surround the surface thereof through the fixing section 132a, while their end portions close to the first island 112 are provided to be movable.

As a result, even if the second and third islands 113 and 114 are respectively disposed on both sides of the first island 112, the connector 100 according to an embodiment of the present disclosure may secure electrical connection stability while reducing the possibility of damage to the second and third islands 113 and 114 due to the external force when coupled with the corresponding connector 200.

In this case, the insulating body 110 of the connector 100 according to an embodiment of the present disclosure may further include a short-circuit barrier 119 extending from the bottom 111 to a predetermined height along the third axis direction.

When the connector 100 according to an embodiment of the present disclosure is surface-mounted on one surface of the circuit board by SMT, the short-circuit barrier 119 may block a solder from moving in the third axis direction along the signal contact 132.

Through this, the short-circuit barrier 119 may prevent a short circuit of the signal contact 132 caused by solder.

For this purpose, the short-circuit barrier 119 may be provided to cover one surface of the fixing section 132a that is fixed to the second or third island 113 or 114 to cover the surface of the second or third island 113 or 114.

In such a case, the short-circuit barrier 119 may extend from the bottom 111 to a predetermined height along the third axis direction.

For example, as illustrated in FIGS. 4 to 6, the short-circuit barrier 119 may include a first short-circuit barrier 119-1 extending from the bottom 111 to a predetermined height to cover one surface of the fixing section 132a of the first signal contact 132-1, and a second short-circuit barrier 119-2 extending from the bottom 111 to a predetermined height to cover one surface of the fixing section 132a of the second signal contact 132-2.

Accordingly, even if the rim area 117 includes cutout areas 118, 118-1, and 118-2 formed at positions corresponding to the signal contact 132 and the signal contact 132 is disposed to be positioned on the side of the cutout area 118, one surface of the fixing section 132a of the signal contact 132 may be prevented from being exposed to the outside through the short-circuit barrier 119.

As a result, when the connector 100 according to an embodiment of the present disclosure is surface-mounted on one surface of the circuit board by SMT, solder (not illustrated) for electrically connecting the fixing section 132a of the signal contact 132 to the circuit board may be blocked from moving in the third axis direction along the fixing section 132a by the short-circuit barrier 119.

Here, a plurality of first signal contacts 132-1 and second signal contacts 132-2 may be provided and spaced apart from each other along the first axis direction.

That is, the plurality of first signal contacts 132-1 may be disposed to be spaced apart from each other along the first axis direction while their respective fixing sections 132a are fixed to the second island 113, and the plurality of second signal contacts 132-2 may be disposed to be spaced apart from each other along the first axis direction while their respective fixing sections 132a are fixed to the third island 114.

Referring again to FIGS. 2 to 7, the shield contact 133 may be disposed along the second axis direction, which is a width direction, to electrically shield the RF contact 131 and the signal contact 132 from each other, and may be disposed between the RF contact 131 and the signal contact 132 that are adjacent to each other.

For example, the shield contact 133 may include a plurality of first shield contacts 133-1 and a plurality of second shield contacts 133-2, and the first shield contacts 133-1 may be disposed along the second axis direction to be positioned between the first RF contact 131-1 and the signal contacts 132, and the second shield contacts 133-2 may be disposed along the second axis direction to be positioned between the second RF contact 131-2 and the signal contacts 132.

Accordingly, the first shield contacts 133-1 may electrically shield the first RF contact 131-1 and the signal contacts 132, and the second shield contacts 133-2 may electrically shield the second RF contact 131-2 and the signal contacts 132.

In this case, the shield contact 133 may be disposed to surround the upper surface, front surface, and side surface of the second island 113 and the upper surface, front surface, and side surface of the third island 114 while surrounding an end portion of the RF contact 131, or may be disposed to surround the upper surface, rear surface, and side surface of the second island 113 and the upper surface, rear surface, and side surface of the third island 114 while surrounding an end portion of the RF contact 131.

That is, the shield contact 133 may be fixed to the insulating body 110 so as to be exposed to the outside while surrounding both ends of the second island 113 and both ends of the third island 114, which protrude from the bottom 111 at a predetermined height.

Moreover, the shield contact 133 may be positioned between the second island 113 and the third island 114, and may be fixed to the insulating body 110 to surround both ends of the first island 112, which protrude from the bottom 111 at a predetermined height.

Accordingly, each of the first island 112, the second island 113, and the third island 114 of the insulating body 110 may have its both ends covered by the shield contact 133, which is made of a metal material.

As a result, each of the first island 112, the second island 113, and the third island 114 may have its both ends structurally reinforced by the shield contact 133.

Additionally, the RF contact 131 may be disposed in the mounting space to be surrounded by the shield contact 133 from at least three directions.

For this purpose, the shield contact 133 may include a first section 133a configured to cover the upper surface, front surface, and side surface of the second island 113 or to cover the upper surface, rear surface, and side surface of the third island 114, a second section 133b configured to cover the upper surface, rear surface, and side surface of the second island 113 or to cover the upper surface, front surface, and side surface of the third island 114, and a third section 133c configured to cover the front surface or rear surface of the first island 112.

In such a case, a portion of the shield contact 133 that surrounds the surface of the first island 112, the surface of the second island 113, and the surface of the third island 114, which protrude from the bottom 111 at a predetermined height, may be exposed to the outside, while a portion corresponding to the bottom surface of the third accommodating space S3 and the bottom surface of the mounting space may not be exposed to the outside.

In addition, each of the first shield contact 133-1 and the second shield contact 133-2 may be formed as a single component, but may also be formed as two components that are physically separated while being arranged along the second axis direction.

Moreover, the third section 133c may be integrally formed with the first section 133a or integrally formed with the second section 133b.

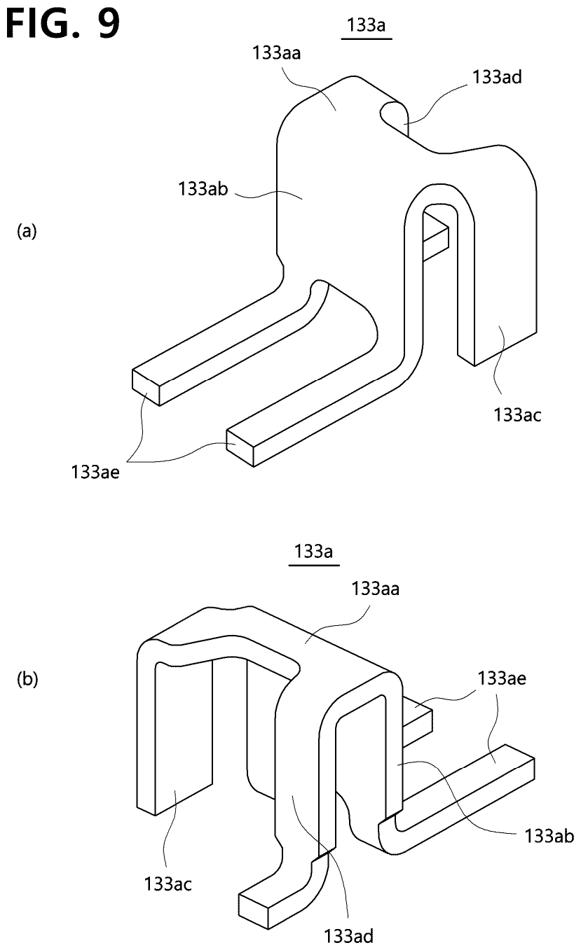

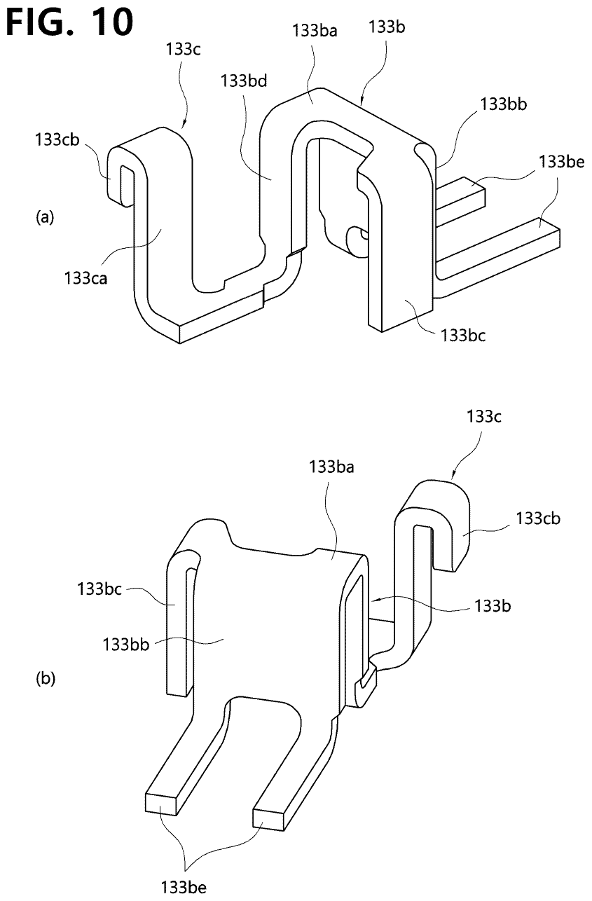

For example, the first section 133a may include an upper section 133aa configured to cover an upper surface of the second island 113 or an upper surface of the third island 114, as illustrated in FIGS. 6, 7, 9, and 10, a first extension section 133ab extending from the upper section 133aa to cover an outer surface of the second island 113 or an outer surface of the third island 114, a second extension section 133ac extending from the upper section 133aa to cover a front surface of the second island 113 or a rear surface of the third island 114, a first contact section 133ad extending from the upper section 133aa to cover an inner surface of the second island 113 or an inner surface of the third island 114, and a mounting section 133ae extending from an end of the first extension section 133ab to be exposed to a lower surface of the bottom 111.

In addition, the second section 133b may include an upper section 133ba configured to cover an upper surface of the second island 113 or an upper surface of the third island 114, a third extension section 133bb extending from the upper section 133ba to cover an outer surface of the second island 113 or an outer surface of the third island 114, a fourth extension section 133bc extending from the upper section 133ba to cover a rear surface of the second island 113 or a front surface of the third island 114, a second contact section 133bd extending from the upper section 133ba to cover an inner surface of the second island 113 or an inner surface of the third island 114, and a mounting section 133be extending from an end of the third extension section 133bb to be exposed to a lower surface of the bottom 111.

Moreover, the third section 133c may include a third contact section 133ca extending from the second section 133b along a height direction of the first island 112 to cover a front surface or a rear surface of the first island 112, and a fixing section 133cb bent from an end of the third contact section 133ca to be embedded in the first island 112.

Here, each of the first contact section 133ad of the first section 133a, the second contact section 133bd of the second section 133b, and the third contact section 133ca of the third section 133c may be a portion configured to form a contact point with the shield contact 233 of the counterpart connector 200.

Accordingly, the RF contact 131 may be disposed in the mounting space to be surrounded by the first section 133a, the second section 133b, and the third section 133c, and may also be disposed to be surrounded by three contact points formed by the shield contact 133 and the shield contact 233 of the counterpart connector 200.

Moreover, since a contact point formed by the shield contact 133 and the shield contact 233 of the counterpart connector 200 is positioned close to the RF contact 131, the shield contact 133 may enhance shielding performance and thus improve RF signal transmission performance.

The shielding performance through the shield contact 133 may be improved as more contact points are formed by the shield contact 133 and the shield contact 233 of the counterpart connector 200, and as the positions of the contact points are distributed in more directions around the RF contact 131. This is because it is important to directly transmit noise from the contact points to the ground side. In particular, a very high-frequency signal, such as an RF signal for 5G, may have a short wavelength and thus experience significant signal attenuation, making it more susceptible to interference from adjacent general signals. Therefore, shielding between the RF contact and the general signal contact may determine the overall signal transmission performance of the connector.

The connector according to an embodiment of the present disclosure may be a very small connector having a width of 1 cm or less and a height of 1 cm or less, which is used in a mobile phone, and even in such a case, the connector according to an embodiment of the present disclosure may minimize signal interference and signal attenuation by optimizing the number and positions of contact points formed by the shield contact 133 and the shield contact 233 of the counterpart connector 200, as described above.

As a specific example, as illustrated in FIGS. 6, 7, 9, and 10, the first shield contact 133-1 may include a first section 133a configured to cover the upper surface, front surface, and side surface of the second island 113, a second section 133b configured to cover the upper surface, front surface, and side surface of the third island 114, and a third section 133c configured to cover the front surface of the first island 112, wherein the third section 133c may be integrally formed with the second section 133b.

That is, the first section 133a may include an upper section 133aa configured to cover an upper surface of the second island 113, a first extension section 133ab extending from the upper section 133aa to cover an outer surface of the second island 113, a second extension section 133ac extending from the upper section 133aa to cover a front surface of the second island 113, a first contact section 133ad extending from the upper section 133aa to cover an inner surface of the second island 113 and to form a contact point with the shield contact 233 of the counterpart connector 200, and a mounting section 133ae extending from an end of the first extension section 133ab to be exposed to a lower surface of the bottom 111.

In addition, the second section 133b may include an upper section 133ba configured to cover an upper surface of the third island 114, a third extension section 133bb extending from the upper section 133ba to cover an outer surface of the third island 114, a fourth extension section 133bc extending from the upper section 133ba to cover a front surface of the third island 114, a second contact section 133bd extending from the upper section 133ba to cover an inner surface of the third island 114 and to form a contact point with the shield contact 233 of the counterpart connector 200, and a mounting tab 133be extending from an end of the third extension section 133bb to be exposed to a lower surface of the bottom 111.

Moreover, the third section 133c may include a third contact section 133ca extending from the second section 133b along the height direction of the first island 112 to cover a front surface of the first island 112, and a fixing section 133cb bent from an end of the third contact section 133ca to be embedded in the first island 112.

In such a case, the first contact section 133ad may be configured to be positioned closer to the first island 112 than the first RF contact 131-1 disposed in the mounting space, the second contact section 133bd may also be configured to be positioned closer to the first island 112 than the first RF contact 131-1, and the third section 133c is configured such that the third contact section 133ca may be integrally extended from the second contact section 133bd of the second section 133b along the height direction of the first island 112.

Accordingly, the second section 133b and the third section 133c may be integrally formed in the first shield contact 133-1, and each of the first contact section 133ad of the first section 133a, the second contact section 133bd of the second section 133b, and the third contact section 133ca of the third section 133c may be disposed to surround a rear surface and both side surfaces of the first RF contact 131-1 disposed in the mounting space.

Through this, the first RF contact 131-1 may be disposed in the mounting space to be surrounded in three directions by the first contact section 133ad of the first section 133a, the second contact section 133bd of the second section 133b, and the third contact section 133ca of the third section 133c.

Accordingly, when the first contact section 133ad of the first section 133a, the second contact section 133bd of the second section 133b, and the third contact section 133ca of the third section 133c form contact points with the shield contact 233 of the counterpart connector 200, the first shield contact 133-1 may be in contact with the shield contact 233 of the counterpart connector 200 at three positions.

As a result, the first RF contact 131-1 may be disposed in the mounting space to be surrounded by three contact points corresponding to the first contact section 133ad of the first section 133a, the second contact section 133bd of the second section 133b, and the third contact section 133ca of the third section 133c, and thus the shielding performance of the first shield contact 133-1 may be enhanced, thereby improving RF transmission performance.

In addition, since the contact points formed by the first shield contact 133 and the shield contact 233 of the counterpart connector 200 may be positioned close to the first RF contact 131-1, the first shield contact 133 may enhance shielding performance, thereby improving the RF transmission performance of the first RF contact 131-1.

Similarly, the second shield contact 133-2 may include a first section 133a configured to cover an upper surface, a rear surface, and a side surface of the third island 114, a second section 133b configured to cover an upper surface, a rear surface, and a side surface of the second island 113, and a third section 133c configured to cover a rear surface of the first island 112, wherein the third section 133c may be integrally formed with the second section 133b.

That is, the first section 133a may include an upper section 133aa configured to cover an upper surface of the third island 114, a first extension section 133ab extending from the upper section 133aa to cover an outer surface of the third island 114, a second extension section 133ac extending from the upper section 133aa to cover a rear surface of the third island 114, a first contact section 133ad extending from the upper section 133aa to cover an inner surface of the third island 114 and to form a contact point with the shield contact 233 of the counterpart connector 200, and a mounting section 133ae extending from an end of the first extension section 133ab to be exposed to a lower surface of the bottom 111.

In addition, the second section 133b may include an upper section 133ba configured to cover an upper surface of the second island 113, a third extension section 133bb extending from the upper section 133ba to cover an outer surface of the second island 113, a fourth extension section 133bc extending from the upper section 133ba to cover a rear surface of the second island 113, a second contact section 133bd extending from the upper section 133ba to cover an inner surface of the second island 113 and to form a contact point with the shield contact 233 of the counterpart connector 200, and a mounting section 133be extending from an end of the third extension section 133bb to be exposed to a lower surface of the bottom 111.

Moreover, the third section 133c may include a third contact section 133ca extending from the second section 133b along the height direction of the first island 112 to cover a rear surface of the first island 112, and a fixing section 133cb bent from an end of the third contact section 133ca to be embedded in the first island 112.

In such a case, the first contact section 133ad may be configured to be positioned closer to the first island 112 than the second RF contact 131-2 disposed in the mounting space, the second contact section 133bd may also be configured to be positioned closer to the first island 112 than the second RF contact 131-2, and the third section 133c is configured such that the third contact section 133ca may be integrally extended from the second contact section 133bd of the second section 133b along the height direction of the first island 112.

Accordingly, the second section 133b and the third section 133c may be integrally formed in the second shield contact 133-2, and each of the first contact section 133ad of the first section 133a, the second contact section 133bd of the second section 133b, and the third contact section 133ca of the third section 133c may be disposed to surround a rear surface and both side surfaces of the second RF contact 131-2 disposed in the mounting space.

Through this, the second RF contact 131-2 may be disposed in the mounting space to be surrounded in three directions by the first contact section 133ad of the first section 133a, the second contact section 133bd of the second section 133b, and the third contact section 133ca of the third section 133c.

Accordingly, when the first contact section 133ad of the first section 133a, the second contact section 133bd of the second section 133b, and the third contact section 133ca of the third section 133c form contact points with the shield contact 233 of the counterpart connector 200, the second shield contact 133-2 may be in contact with the shield contact 233 of the counterpart connector 200 at three positions.

As a result, the second RF contact 131-2 may be disposed in the mounting space to be surrounded by three contact points corresponding to the first contact section 133ad of the first section 133a, the second contact section 133bd of the second section 133b, and the third contact section 133ca of the third section 133c, and thus the shielding performance of the second shield contact 133-2 may be enhanced, thereby improving the RF transmission performance of the second RF contact 131-2.

In addition, since the contact points formed by the second shield contact 133-2 and the shield contact 233 of the counterpart connector 200 may be positioned close to the second RF contact 131-2, the second shield contact 133-2 may enhance shielding performance, thereby improving the RF transmission performance of the second RF contact 131-2.

As described above, in the connector 100 according to an embodiment of the present disclosure, the shield contact 133 made of a metal material may be disposed to surround the surfaces at both ends of the first island 112, the second island 113, and the third island 114, and thus, each of the first island 112, the second island 113, and the third island 114 may have its end strength reinforced through the shield contact 133.

As a result, the connector 100 according to an embodiment of the present disclosure may smoothly implement the multi-contact structure of the contact section 130 while reinforcing the strength of the first island 112, the second island 113, and the third island 114, thereby further reducing the possibility of damage to the first island 112, the second island 113, and the third island 114 due to misalignment.

Moreover, the connector 100 according to an embodiment of the present disclosure may be disposed in the insulating body 110 such that the RF contact 131 is surrounded by three contact points formed between the shield contact 133 and the shield contact 230 of the counterpart connector 200, and thus, the RF contact 131 may have enhanced shielding performance by the shield contact 133, thereby further improving RF transmission performance.

Although the third section 133c is illustrated in the drawings as being integrally formed with the second section 133b, the present disclosure is not limited thereto, and the third section 133c may instead be integrally formed with the first section 133a. In such a case, the third contact section 133ca of the third section 133c may be integrally extended from the first contact section 133ad of the first section 133a along the height direction of the first island 112.

Meanwhile, the counterpart connector 200 according to an embodiment of the present disclosure may be configured such that, when physically coupled with the connector 100 described above, the contacts corresponding to each other may form multiple contact points.

That is, the corresponding connector 200 according to an embodiment of the present disclosure may reduce the possibility of damage caused by physical contact when being coupled with the connector 100, while securing contact stability through a multi-contact structure of contacts corresponding to each other.

In addition, the corresponding connector 200 according to an embodiment of the present disclosure may improve RF signal transmission performance by improving contact point positions of shield contacts 233 corresponding to the shield contact 133 of the connector 100.

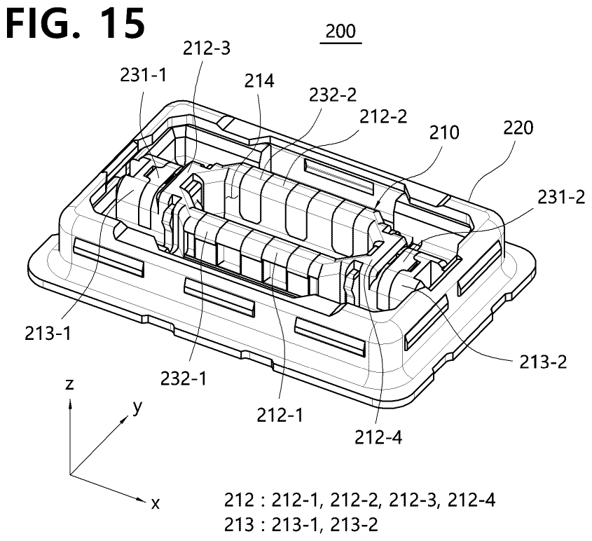

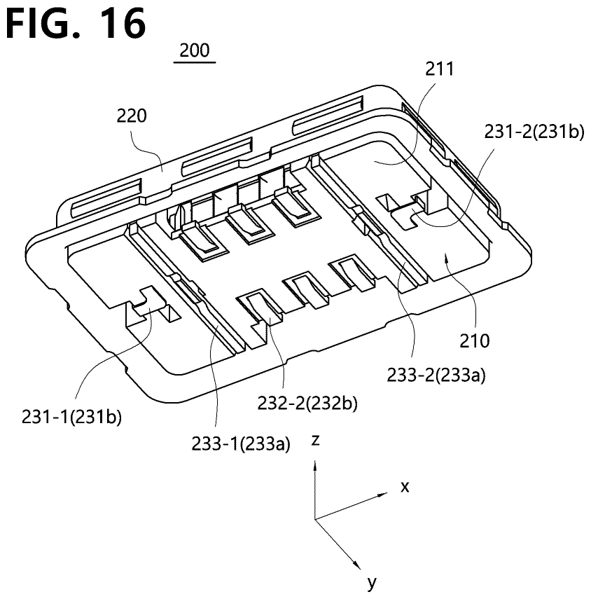

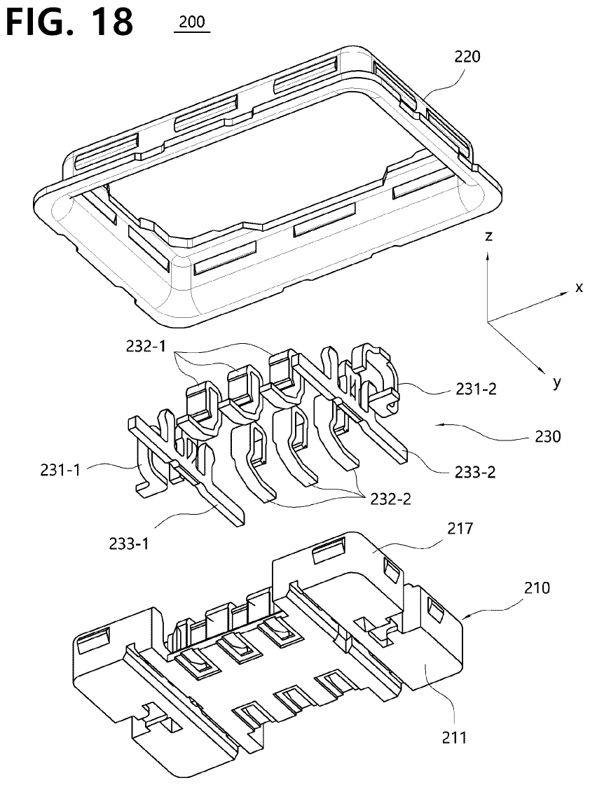

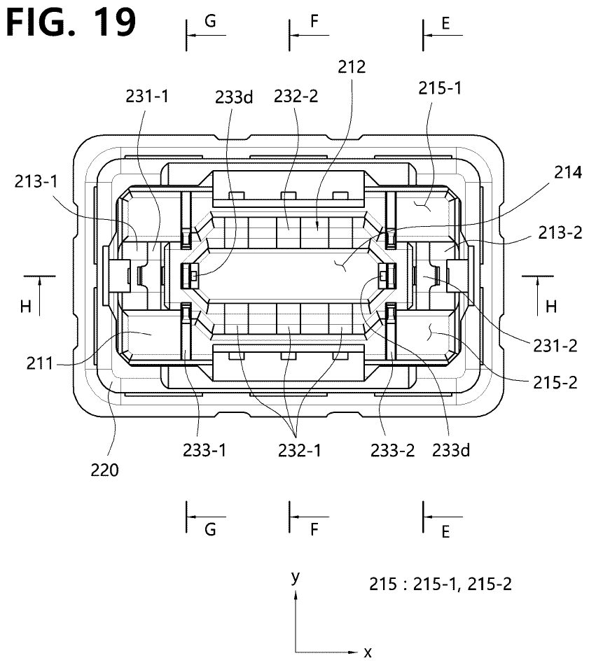

For this purpose, the corresponding connector 200 according to an embodiment of the present disclosure may include an insulating body 210, a shield 220, and a contact 230, as illustrated in FIGS. 15 to 19.

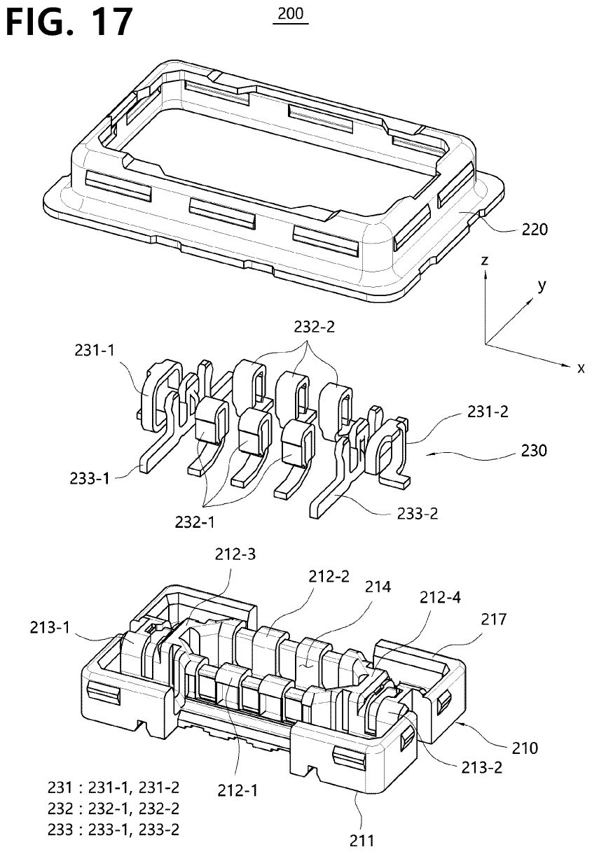

The insulating body 210 may be made of an electrically insulating material and may define the overall outer shape of the corresponding connector 200. For example, the insulating body 210 may have a substantially rectangular parallelepiped shape, as illustrated in FIG. 17.

The insulating body 210 may be provided in a shape corresponding to the connector 100 so that the corresponding connector 200 may be physically coupled with the connector 100.

In addition, the insulating body 210 may be configured to reduce the possibility of damage due to physical contact when coupled with the connector 100, while allowing contacts corresponding to each other to form multiple contact points.

That is, the corresponding connector 200 according to an embodiment of the present disclosure may be configured such that, when coupled with the connector 100, contact points of the shield contacts 133 and 233 corresponding to each other are disposed to surround the RF contact 231, and the RF contact 231 may be disposed to be surrounded by three contact points of the shield contacts that are formed not to be aligned in a straight line.

For this purpose, the insulating body 210 may include an accommodating groove 214 and a seating groove 215 formed to allow the three islands 112, 113, and 114 to be individually inserted therein.

In such a case, the insulating body 210 may include a plate-shaped bottom 211 having a predetermined area, and a ring-shaped island 212 configured to protrude from the bottom 211 at a predetermined height so as to form the accommodating groove 214 and the seating groove 215.

That is, the ring-shaped island 212 may protrude from the bottom 211 at a predetermined height so as to form the accommodating groove 214 for accommodating the first island 112 and the seating groove 215 for accommodating the second island 113 and the third island 114.

Here, the ring-shaped island 212 may be inserted into the first accommodating space S1 and the second accommodating space S2 of the connector 100 when the connector 100 is coupled with the corresponding connector 200, and the contact 230 may form multiple contact points with the contact 130 of the connector 100 when the ring-shaped island 212 is inserted into the first accommodating space S1 and the second accommodating space S2.

In addition, the accommodating groove 214 may be configured to be positioned inside the ring-shaped island 212, and the seating groove 215 may be configured to surround the ring-shaped island 212 outside the ring-shaped island 212.

Accordingly, when the corresponding connector 200 according to an embodiment of the present disclosure is coupled with the connector 100, the first island 112 may be inserted into the accommodating groove 214, and the second island 113 and the third island 114 respectively disposed on both sides of the first island 112 may be inserted into the seating groove 215.

In this case, the ring-shaped island 212 may be provided in a closed-loop shape to have improved strength regardless of direction.

Moreover, the corresponding connector 200 according to an embodiment of the present disclosure may further include a connection island 213 to enhance the strength of the ring-shaped island 212.

That is, the insulating body 210 may include a rim area 217 extending at a predetermined height upward along a rim of the bottom 211, and a connection island 213 extending at a predetermined length along a first axial direction as a longitudinal direction from the ring-shaped island 212.

In such a case, the connection island 213 may protrude from the bottom 211 at a predetermined height to connect the rim area 217 and the ring-shaped island 212 to each other.

As a specific example, as illustrated in FIGS. 15, 17, and 19, the ring-shaped island 212 may be configured such that a first island section 212-1, a second island section 212-2, a third island section 212-3, and a fourth island section 212-4 having a predetermined length are connected to one another to form a closed-loop shape.

In addition, the connection island 213 may include a first connection island 213-1 connecting the third island section 212-3 and the rim area 217, and a second connection island 213-2 connecting the fourth island section 212-4 and the rim area 217.

In such a case, the first and second island sections 212-1 and 212-2 may be configured to be spaced apart from each other along a second axial direction as a width direction and to have a predetermined length along a first axial direction as a longitudinal direction, and the third and fourth island sections 212-3 and 212-4 may be configured to be spaced apart from each other along the first axial direction as a longitudinal direction and to have a predetermined length along the second axial direction as a width direction.

In addition, the third island section 212-3 may connect one end of the first island section 212-1 and one end of the second island section 212-2, and the fourth island section 212-4 may connect the other end of the first island section 212-1 and the other end of the second island section 212-2.

Moreover, the first connection island 213-1 may be configured to have a predetermined length along a first axial direction to connect the third island section 212-3 and the rim area 217 facing each other, and the second connection island 213-2 may be configured to have a predetermined length along the first axial direction to connect the fourth island section 212-4 and the rim area 217 facing each other.

Accordingly, the ring-shaped island 212 may be configured to have a closed-loop shape through a first island section 212-1, a third island section 212-3, a second island section 212-2, and a fourth island section 212-4, which are sequentially connected along one direction, and to be connected to the rim area 217 through the first connection island 213-1 and the second connection island 213-2.

Through this, even if a load is applied to the first island section 212-1 or the second island section 212-2 through physical contact when the corresponding connector 200 and the connector 100 are coupled, the first island section 212-1 or the second island section 212-2 may withstand the load through the third island section 212-3 and the fourth island section 212-4, which are disposed in a direction substantially parallel to a load direction applied to the first island section 212-1 or the second island section 212-2, while being connected to each other.

Similarly, even if a load is applied to the third island section 212-3 or the fourth island section 212-4 through physical contact when the corresponding connector 200 and the connector 100 are coupled, the third island section 212-3 or the fourth island section 212-4 may withstand the load through the first connection island 213-1 or the second connection island 213-2 that interconnect the ring-shaped island 212 and the rim area 217.

As a result, the ring-shaped island 212 may have improved strength regardless of the direction of the applied load, thereby reducing the possibility of damage due to physical contact when the corresponding connector 200 and the connector 100 are coupled.

In particular, the corresponding connector 200 according to an embodiment of the present disclosure may more effectively withstand a load applied along the first axial direction because the ring-shaped island 212 is connected to the rim area 217 through the first connection island 213-1 and the second connection island 213-2.

Moreover, the contact 230 may be made of a metal material, and the contact 230 made of a metal material may be fixed to the insulating body 210 to surround a surface of the ring-shaped island 212 and the connection island 213, which protrude from the bottom 211 at a predetermined height, and to be exposed to the outside.

Accordingly, the ring-shaped island 212 may have its surface protected by the contact 230 having a relatively higher strength than the insulating body 210 to reinforce its own strength, and thus the possibility of damage due to physical contact when the corresponding connector 200 is coupled with the connector 100 may be further reduced.

Through this, the corresponding connector 200 according to an embodiment of the present disclosure may secure contact stability through a structure configured to form multiple contact points between corresponding contacts, and the possibility of damage due to physical contact may be reduced even when misalignment occurs when the corresponding connector 200 is coupled with the connector 100.

In such a case, the seating groove 215 configured to surround the ring-shaped island 212 on its outer side may be divided into two parts by the first connection island 213-1 and the second connection island 213-2.

That is, the seating groove 215 may include a first seating groove 215-1 defined by the first island section 212-1, the rim area 217, the second connection island 213-2, and the second connection island 213-2, and a second seating groove 215-2 defined by the second island section 212-2, the rim area 217, the second connection island 213-2, and the second connection island 213-2.

Accordingly, when the corresponding connector 200 and the connector 100 are coupled to each other, the second island part 113 of the connector 100 may be inserted into the first seating groove 215-1, and the third island part 114 of the connector 100 may be inserted into the second seating groove 215-2.

The shield 220 may prevent damage of the insulating body 210 due to excessive pressure when coupled with the connector 100, while shielding electromagnetic waves introduced from the outside.

In addition, the shield 220 may shield electromagnetic waves generated from the contact 230 coupled to the insulating body 210.

For this purpose, the shield 220 may be made of a metal material, but is not limited thereto, and any known material may be used as long as it has a predetermined strength and electrical conductivity.

As illustrated in FIGS. 15 to 19, the shield 220 may be coupled to the insulating body 210 to surround the entire edge of the insulating body 210.

For this purpose, the insulating body 210 may include a rim area 217 configured to extend from the bottom 211 at a predetermined height, and the rim area 217 may be configured to extend from a rim of the bottom 211 at the predetermined height to be spaced apart from the ring-shaped island 212.

Accordingly, when the shield 220 is coupled to the rim area 217, the shield 220 may be disposed to surround the rim of the insulating body 210.

Through this, when the corresponding connector 200 according to an embodiment of the present disclosure is coupled with the connector 100, the shield 220 may be brought into contact with the shield 120 of the connector 100 and may be electrically connected to form a ground together with a shield contact 233 to be described later.

The contact 230 may be coupled to the insulating body 210 and may be electrically connected to the outside.

For this purpose, the contact 230 may be made of a conductive material such as a metal and may be coupled to the insulating body 210 such that at least a portion thereof is exposed to the outside.

The contact 230 may include a plurality of contacts for a predetermined function, and the plurality of contacts may be coupled to the insulating body 210 to be in contact with a contact of the connector 100 or a substrate.

In addition, the contact 230 may be disposed to be positioned at locations respectively corresponding to the contact 130 of the connector 100 described above.

That is, the contact 230 may be coupled to the insulating body 210 to be in contact with the contacts of the connector 100 respectively corresponding thereto when the corresponding connector 200 and the connector 100 are coupled to each other.

Here, the contact 230 may be detachably coupled to the insulating body 210, or may be integrally formed with the insulating body 210 through insert molding.

Through this, the contact 230 may form an electrical contact with the contact 130 of the connector 100 when the corresponding connector 200 and the connector 100 are coupled to each other.

In this case, the contact 230 may be configured, like the contact 130 described above, to simultaneously transmit a radio frequency (RF) signal and a general signal, and may be provided in the insulating body 210 to form multiple contact points with the contact 130 of the connector 100.

In addition, the RF contact 231 among the contacts 230 may be disposed to be surrounded by three contact points of the shield contacts that are formed not to be aligned in a straight line.

That is, the RF contact 231 may be disposed in the insulating body 210 to be surrounded by the shield contacts that form contact points with each other at both side surfaces as well as at a front or rear side of the RF contact 231, without being positioned in a straight line.

Moreover, the contact 230 may be fixed to the insulating body 210 to surround the surface of the ring-shaped island 212 and the surface of the connection island 213, which protrude from the bottom 211 at a predetermined height, and to be exposed to the outside.

Accordingly, since the contact 230 made of a metal material is fixed to the insulating body 210 to surround the surfaces, the ring-shaped island 212 and the connection island 213 may have their strengths reinforced through the contact 230 surrounding the surfaces.

For example, the contact 230 may include an RF contact 231 for transmitting an RF signal, a signal contact 232 for transmitting a general signal, and a shield contact 233 for electrical shielding, and each of the RF contact 231, the signal contact 232, and the shield contact 233 may be provided in the insulating body 210 to form multiple point contacts with the contact 130 of the connector 100.

In addition, each of the RF contact 231, the signal contact 232, and the shield contact 233 may be provided in a plurality spaced apart from one another along the first axis direction, and the signal contact 232 may be fixed to the ring-shaped island 212 to surround its surface, and the RF contact 231 may be fixed to the connection island 213 to surround its surface.

As a specific example, as illustrated in FIGS. 17 to 20, the plug RF contact 231 may include a first RF contact 231-1 and a second RF contact 231-2 that are spaced apart from each other along a first axial direction.

In such a case, when the corresponding connector 200 is coupled with the connector 100, the RF contact 231 may be provided in the insulating body 210 to be brought into contact with the RF contact 131 provided in the mounting space at two locations, as illustrated in FIG. 26, and may also be provided in the insulating body 210 to reinforce the strength of the connection island 213.

Here, the first RF contact 231-1 may be fixed to the first connection island 213-1 to surround its surface and be exposed to the outside, and the second RF contact 231-2 may be fixed to the second connection island 213-2 to surround its surface and be exposed to the outside.

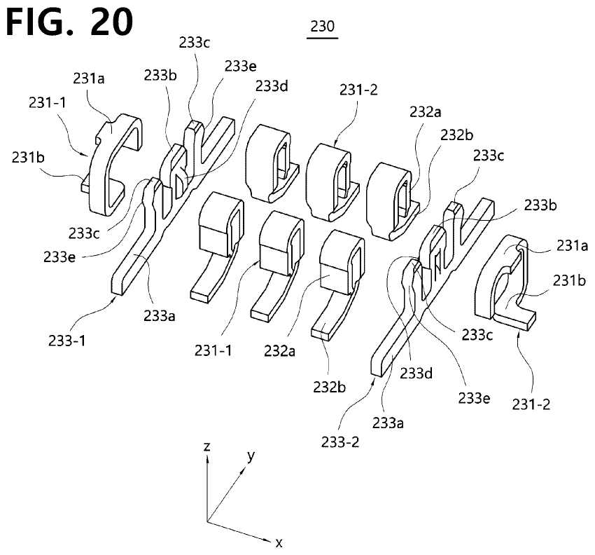

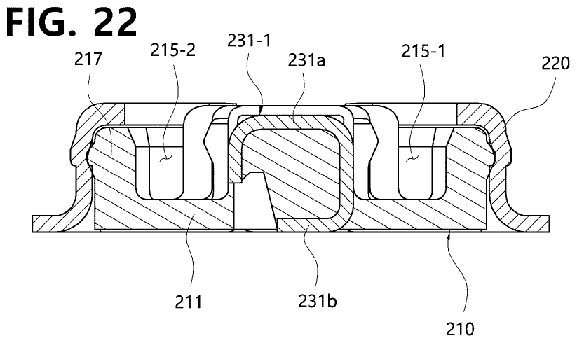

For this purpose, as illustrated in FIGS. 20, 22, and 26, the first RF contact 231-1 may include an exposed section 231a that is fixed to the first connection island 213-1 to surround its surface and be exposed to the outside, and a buried section 231b that extends from the exposed portion 231a and is embedded in the bottom 211.

Here, the buried section 231b may be embedded in the bottom 211 and be exposed to the outside through a lower surface of the insulating body 210.

Accordingly, the first RF contact 231-1 may smoothly form double contact points with the first RF contact 131-1 of the connector 100 through the exposed section 231a, and may be electrically connected with another component such as a circuit board through the buried section 231b.

Similarly, the second RF contact 231-2 may include an exposed section 231a that is fixed to the second connection island 213-2 to surround its surface and be exposed to the outside, and a buried section 231b that extends from the exposed section 231a and is embedded in the bottom 211.

Here, the buried section 231b may be embedded in the bottom 211 and be exposed to the outside through a lower surface of the insulating body 210.

Accordingly, the second RF contact 231-2 may smoothly form double contact points with the second RF contact 131-2 of the connector 100 through the exposed section 231a, and may be electrically connected with another component such as a circuit board through the buried section 231b.

Referring again to FIGS. 17 to 20, the signal contact 232 may include a first signal contact 232-1 and a second RF contact 232-2 that are spaced apart from each other along a second axial direction.

In such a case, the first signal contact 232-1 and the second signal contact 232-2 may be disposed to be positioned between the first RF contact 231-1 and the second RF contact 231-2 along the first axial direction.

In this case, the first signal contact 232-1 may be fixed to the first island section 212-1 to surround its surface and be exposed to the outside, and the second signal contact 232-2 may be fixed to the second island section 212-2 to surround its surface and be exposed to the outside.

In addition, the signal contact 232 may be provided in the insulating body 210 to form double contact points with the signal contact 132 of the connector 100.

That is, when the connector 100 and the corresponding connector 200 are coupled with each other, the signal contact 232 may be brought into contact with the signal contact 132 of the connector 100 at two locations, as illustrated in FIG. 27.

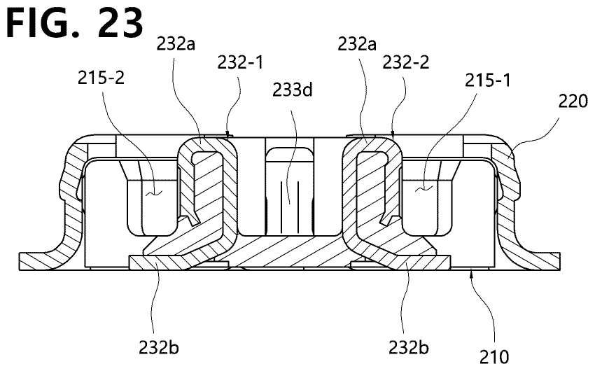

For this purpose, as illustrated in FIGS. 20 and 23, the first signal contact 232-1 may include a fixing section 232a that is fixed to the first island section 212-1 to surround its surface and be exposed to the outside, the first island section 212-1 protruding from the bottom 211 at a predetermined height, and a bottom section 232b that extends from the fixing section 232a and is embedded in the bottom 211.

Accordingly, when the connector 100 is coupled with the corresponding connector 200, the first signal contact 232-1 may form double contact points with the first signal contact 132-1 of the connector 100 through the protrusion section 132d and the movable section 132c of the first signal contact 132-1, as illustrated in FIG. 27.

Similarly, as illustrated in FIG. 20, the second signal contact 232-2 may include a fixing section 232a that is fixed to the second island section 212-2 to surround its surface and be exposed to the outside, the second island section 212-2 protruding from the bottom 211 at a predetermined height, and a bottom section 232b that extends from the fixing section 232a and is embedded in the bottom 211.

Accordingly, when the connector 100 is coupled with the corresponding connector 200, the second signal contact 232-2 may form double contact points with the second signal contact 132-2 of the connector 100 through the protrusion section 132d and the movable section 132c of the second signal contact 132-2.

As described above, in the corresponding connector 200 according to an embodiment of the present disclosure, the signal contact 232 and the RF contact 231 may respectively form double contact points with the signal contact 132 and the RF contact 131 of the connector 100.

As a result, the corresponding connector 200 according to an embodiment of the present disclosure may transmit both an RF signal and a general signal, and may secure conduction stability for both the RF signal and the general signal through double contact points method.

In addition, the corresponding connector 200 according to an embodiment of the present disclosure may have its strength reinforced through the fixing section 232a, because the first signal contact 232-1 and the second signal contact 232-2, made of a metal material, are fixed to the first island section 212-1 or the second island section 212-2 to surround the surface of the first island section 212-1 or the second island section 212-2 through the fixing section 232a.

Similarly, in the corresponding connector 200 according to an embodiment of the present disclosure, the connection island 213 may have its strength reinforced through the exposed section 231a, because the RF contact 231, made of a metal material, is fixed to the connection island 213 to surround its surface through the exposed section 231a, in order to form double contact points with the RF contact 131 of the connector 100.

As a result, the corresponding connector 200 according to an embodiment of the present disclosure may reduce the possibility of damage to the ring-shaped island 212 and the connection island 213 due to an external force when coupled with the connector 100, while securing electrical connection stability.

Here, a plurality of first signal contacts 232-1 and second signal contacts 232-2 may be provided and spaced apart from each other along the first axial direction.

That is, the plurality of first signal contacts 232-1 may be disposed to be spaced apart from each other along the first axial direction while their respective fixing sections 232a are fixed to the first island section 212-1, and the plurality of second signal contacts 232-2 may be disposed to be spaced apart from each other along the first axial direction while their respective fixing sections 232a are fixed to the second island section 212-2.

Referring again to FIGS. 17 to 20, the shield contact 233 may be disposed along the second axial direction, which is a width direction, to electrically shield the RF contact 231 and the signal contact 232 from each other, and may be disposed between the RF contact 231 and the signal contact 232 that are adjacent to each other.

For example, the shield contact 233 may include a plurality of first shield contacts 233-1 and a plurality of second shield contacts 233-2, and the first shield contacts 233-1 may be disposed along the second axial direction to be positioned between the first RF contact 231-1 and the signal contacts 232, and the second shield contacts 233-2 may be disposed along the second axial direction to be positioned between the second RF contact 231-2 and the signal contacts 232.

As a result, the first shield contact 233-1 may electrically shield the first RF contact 231-1 and the signal contact 232, and the second shield contact 233-2 may electrically shield the second RF contact 231-2 and the signal contact 232.

In this case, the shield contact 233 may be configured to come into contact with the shield contact 133 of the connector 100 in both the first axial direction and the second axial direction, when coupled with the connector 100.

That is, the shield contact 233 may be configured such that its contact point with the shield contact 133 of the connector 100 is not aligned in a straight line, while surrounding the RF contact 231 when coupled with the connector 100.

For this purpose, the shield contact 233 may include a body 233a that is disposed along the second axial direction and embedded in the bottom 211, a first leg 233b that extends from the body 233a and is exposed in the accommodating groove 214 to be fixed to the ring-shaped island 212, and a pair of second legs 233c that extend from the body 233a and are exposed outside the ring-shaped island 212 to be fixed to the ring-shaped island 212.

In such a case, the first leg 233b may extend from the body 233a to be positioned between the pair of second legs 233c, with a predetermined distance between each second leg 233c.

In addition, the shield contact 233 may include a first protrusion 233d configured to protrude from the body 233a along the first axial direction and second protrusions 233e configured to protrude from the body 233a along the second axial direction.

For example, the first protrusion 233d may be formed on the first leg 233b to protrude from the first leg 233b toward the accommodating groove 214 along the first axial direction, and the second protrusions 233e may be formed on the second leg 233c to protrude from the second leg 233c to the outside along the second axial direction.

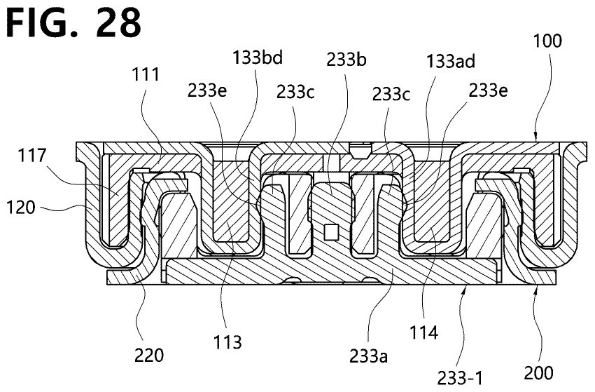

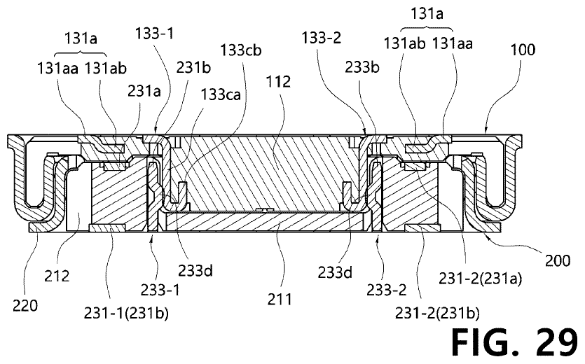

As a result, when the connector 100 and the corresponding connector 200 are coupled, as illustrated in FIGS. 28 and 29, the first protrusion 233d may be in contact with the third contact section 133c of the shield contact 133 described above in the accommodation groove 214, and the second protrusions 233e may be in contact with the first contact section 133ad and the second contact section 133bd of the shield contact 133 described above, respectively.

As a result, the RF contact 231 may be surrounded by the first protrusion 233d and the second protrusions 233e, and by three contact points formed so as not to be positioned in a straight line, which are the first contact section 133ad, the second contact section 133bd, and the third contact section 133c.

Moreover, the contact point formed by the shield contact 233 and the shield contact 133 of the connector 100 may be configured to be positioned close to the RF contact 231.

The shielding performance through the shield contact 233 may be improved as more contact points are formed by the shield contact 233 and the shield contact 133 of the counterpart connector 100, and as the positions of the contact points are distributed in more directions around the RF contact 231. This is because it is important to directly transmit noise from the contact points to the ground side. In particular, a very high-frequency signal, such as an RF signal for 5G, may have a short wavelength and thus experience significant signal attenuation, making it more susceptible to interference from adjacent general signals. Therefore, shielding between the RF contact and the general signal contact may determine the overall signal transmission performance of the connector.

The connector according to an embodiment of the present disclosure may be a very small connector having a width of 1 cm or less and a height of 1 cm or less, which is used in a mobile phone. Even in such a case, the connector according to an embodiment of the present disclosure may minimize signal interference and signal attenuation by optimizing the number and positions of contact points formed by the shield contact 133 and the shield contact 233 of the counterpart connector 100, as described above.

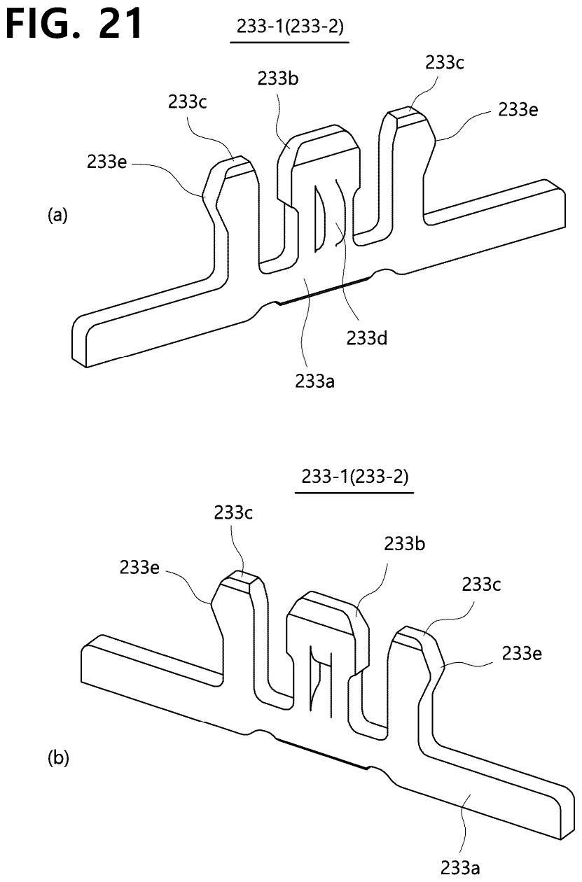

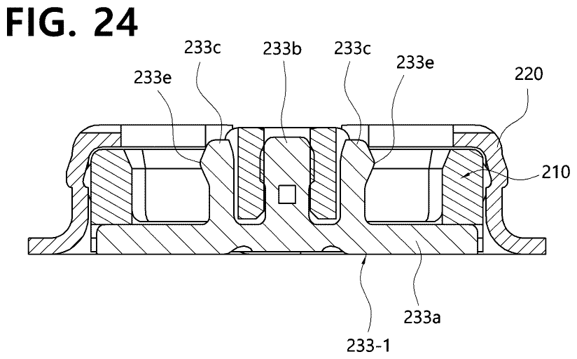

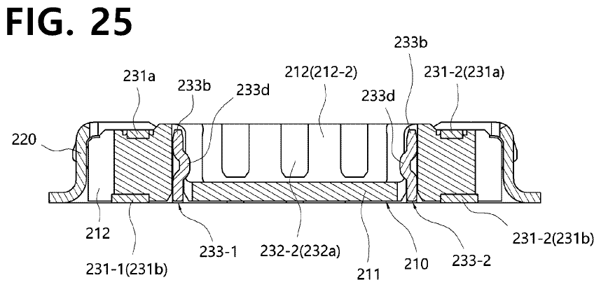

As a specific example, as illustrated in FIGS. 20, 21, 24, and 25, the first shield contact 233-1 may include a body 233a disposed along the second axis direction and embedded in the bottom 211, a first leg 233b configured to extend from the body 233a, exposed in the accommodating groove 214, and fixed to the ring-shaped island 212, and a pair of second legs 233c configured to extend from the body 233a, exposed on the outer side of the ring-shaped island 212, and fixed to the ring-shaped island 212.

In this case, the first leg 233b may extend from the body 233a to be positioned between the pair of second legs 233c, with a predetermined distance between each second leg 233c.

In addition, the first shield contact 233-1 may include a first protrusion 233d formed on the first leg 233b to protrude from the body 233 toward the accommodating groove 214 along the first axis direction, and the second protrusions 233e formed on the second leg 233c to protrude from the second leg 233c to the outside along the second axis direction.

Accordingly, as illustrated in FIGS. 28 and 29, when the connector 100 and the corresponding connector 200 are coupled, the first protrusion 233d may come into contact with the third contact section 133c of the first shield contact 133-1 within the accommodating groove 214, and the second protrusions 233e may come into contact with the first contact section 133ad and the second contact section 133bd of the first shield contact 133-1, respectively.

Through this, the first shield contact 233-1 may make contact at three points with the first shield contact 133-1 of the connector 100 through the first protrusion 233d and the second protrusions 233e.

As a result, the first RF contact 231-1 may be surrounded on the front and both sides by one contact point formed by the first shield contact 133-1 along the first axial direction via the first protrusion 233d, and by two contact points formed along the second axial direction by the second protrusion 233e, thereby improving the shielding performance by the first shield contact 233-1 and enhancing RF transmission performance.

In addition, since the first RF contact 231-1 may be configured such that the contact points formed by the first shield contact 233-1 and the first shield contact 133-1 of the connector 100 are positioned close to the first RF contact 231-1, the first shield contact 233 may enhance shielding performance and thereby improve the RF transmission performance of the first RF contact 231-1.

Similarly, the second shield contact 233-2 may include a body 233a disposed along the second axis direction and embedded in the bottom 211, a first leg 233b extending from the body 233a to be exposed in the accommodating groove 214 and fixed to the ring-shaped island 212, and a pair of second legs 233c extending from the body 233a to be exposed on the outer side of the ring-shaped island 212 and fixed to the ring-shaped island 212

As described above, the first leg 233b may extend from the body 233a to be positioned between the pair of second legs 233c, with a predetermined distance between each of the second legs 233c.

In addition, the second shield contact 233-2 may include a first protrusion 233d formed on the first leg 233b to protrude from the body 233 toward the accommodating groove 214 along the first axis direction, and a second protrusion 233e formed on the second leg 233c to protrude from the second leg 233c outward along the second axis direction.

Accordingly, as illustrated in FIGS. 28 and 29, when the connector 100 and the corresponding connector 200 are coupled, the first protrusion 233d may contact the third contact section 133c of the second shield contact 133-2 within the accommodating groove 214, and the second protrusions 233e may contact the first contact section 133ad and the second contact section 133bd of the second shield contact 133-2, respectively.

Through this, the second shield contact 233-2 may make contact at three points with the second shield contact 133-2 of the connector 100 through the first protrusion 233d and the second protrusion 233e.

As a result, the second RF contact 231-2 may be surrounded on the front and both sides by one contact point formed by the second shield contact 133-2 along the first axial direction via the first protrusion 233d, and by two contact points formed along the second axial direction by the second protrusion 233e, thereby improving the shielding performance by the second shield contact 233-2 and enhancing RF transmission performance.

Additionally, since the second RF contact 231-2 may be configured such that the contact points formed by the second shield contact 233-2 and the second shield contact 133-2 of the connector 100 are positioned close to the second RF contact 231-2, the second shield contact 233 may improve shielding performance, thereby enhancing the RF transmission performance of the second RF contact 231-2.

Similarly, the corresponding connector 200 according to an embodiment of the present disclosure may be disposed in the insulating body 210 such that the RF contact 231 is surrounded by three contact points formed between the shield contact 233 and the shield contact 130 of the connector 100, and thus, the RF contact 231 may have enhanced shielding performance by the shield contact 233, thereby further improving RF transmission performance.

Meanwhile, in the corresponding connector 200 according to an embodiment of the present disclosure, the connection island 213 may protrude from the bottom 211 at a predetermined height, such that it has a lower height than the ring-shaped island 212.

That is, the first connection island 213-1 and the second connection island 213-2, which interconnect the ring-shaped island 212 and the rim 217, may be provided to have a lower height than the ring-shaped island 212 along the third direction.

Through this, when the corresponding connector 200 and the connector 100 are coupled, the possibility that the end sides of the second island 113 and the third island 114 will first make contact with the ring-shaped island 212 may be reduced.

Through this, the possibility that the ring-shaped island 212 will physically contact the shield contact 133, which is made of a metal material, while surrounding the end sides of the second island 113 and the third island 114, may be reduced, and the possibility of damage to the ring-shaped island 212 due to physical contact may also be minimized.

As described above, since the signal contact 232 is provided on the ring-shaped island 212 and the RF contact 231 is provided on the connection island 213, when the corresponding connectors 200 and 100 are coupled, the signal contacts 132-1, 132-2, 232-1, and 232-2 corresponding to each other may first make contact, followed by the RF contacts 131-1, 131-2, 231-1, and 231-2 corresponding to each other.

Accordingly, even when the corresponding connector 200 and the connector 100 are coupled in a misaligned state, the possibility of damage to the RF contacts 131-1, 131-2, 231-1, and 231-2 due to misalignment may be further reduced.

Although exemplary embodiments of the present disclosure have been described, the spirit of the present disclosure is not limited to the embodiments set forth herein. Those of ordinary skill in the art who understand the spirit of the present disclosure may easily propose other embodiments through supplement, change, removal, addition, etc. of elements within the same scope of spirit, but the embodiments will be also within the scope of the present disclosure.

1. A connector comprising:
an insulating body including three bar-shaped islands, each configured to have a predetermined length along a first axis direction as a longitudinal direction and to protrude from a bottom at a predetermined height, the three bar-shaped islands being spaced apart from one another along a second axis direction perpendicular to the first axis;
a shield configured to be made of a conductive material, and coupled to a rim area along a rim of the insulating body; and
a contact configured to be coupled to the insulating body to be electrically connected to an outside,
wherein the three bar-shaped islands include a first island, and a second island and a third island disposed on both sides of the first island along the second axis direction as a width direction,
wherein the contact includes an RF contact for transmitting an RF signal, a signal contact for transmitting a general signal, and a shield contact for electrical shielding, and
wherein the RF contact is disposed to be positioned between the second island and the third island facing each other, and
wherein the shield contact is disposed to surround an end of the RF contact and to cover an upper surface, a front surface, and a side surface of the second island and an upper surface, a front surface, and a side surface of the third island, or is disposed to surround an end of the RF contact and to cover an upper surface, a rear surface, and a side surface of the second island and an upper surface, a rear surface, and a side surface of the third island.

2. The connector of claim 1, wherein the first island is configured to have a relatively shorter length along the first axis direction than the second island and the third island.

3. The connector of claim 2, wherein the RF contact includes
a first RF contact and a second RF contact,
the first RF contact being disposed outside a front surface of the first island at a predetermined distance along the first axis direction, and
the second RF contact being disposed outside a rear surface of the first island by a predetermined distance along the first axis direction.

4. The connector of claim 3, wherein the first RF contact is disposed to be positioned between a virtual straight line connecting the front surfaces of the second island and the third island and the front surface of the first island,
and the second RF contact is disposed to be positioned between a virtual straight line connecting the rear surfaces of the second island and the third island and the rear surface of the first island.

5. The connector of claim 3, wherein the shield contact includes:
a first section configured to cover the upper surface, the front surface, and the side surface of the second island or the upper surface, the rear surface, and the side surface of the third island;
a second section configured to cover the upper surface, the rear surface, and the side surface of the second island or the upper surface, the front surface, and the side surface of the third island; and
a third section configured to cover the front surface or the rear surface of the first island,
wherein the RF contact is disposed to be surrounded by the first section, the second section, and the third section.

6. The connector of claim 5, wherein the third section is integrally formed with the first section or integrally formed with the second section.

7. The connector of claim 5, wherein the first section, the second section, and the third section each include a portion forming a contact point with a shield contact of a counterpart connector.

8. The connector of claim 5, wherein the first section includes:
an upper section configured to cover the upper surface of the second island or the upper surface of the third island,
a first extension section configured to extend from the upper section to cover an outer side surface of the second island or an outer side surface of the third island,
a second extension section configured to extend from the upper section to cover the front surface of the second island or the rear surface of the third island,
a first contact section configured to extend from the upper section to cover an inner side surface of the second island while forming a contact point with a shield contact of a counterpart connector, or to cover an inner side surface of the third island while forming a contact point with a shield contact of a counterpart connector, and
a mounting section configured to extend from an end of the first extension section to be exposed to a lower surface of the bottom.

9. The connector of claim 5, wherein the second section includes:
an upper section configured to cover the upper surface of the second island or the upper surface of the third island,
a third extension section configured to extend from the upper section to cover an outer side surface of the second island or an outer side surface of the third island,
a fourth extension section configured to extend from the upper section to cover the rear surface of the second island or the front surface of the third island,
a second contact section configured to extend from the upper section to cover an inner side surface of the second island while forming a contact point with a shield contact of a counterpart connector, or to cover an inner side surface of the third island while forming a contact point with a shield contact of a counterpart connector, and
a mounting section configured to extend from an end of the third extension section to be exposed to a lower surface of the bottom.

10. The connector of claim 5, wherein the third section includes:
a third contact section configured to extend from the first section or the second section along a height direction of the first island to cover the front surface of the first island or the rear surface of the first island while forming a contact point with a shield contact of a counterpart connector, and
a fixing section configured to be bent from an end of the third contact section to be embedded in the first island.

11. The corresponding connector of claim 3, wherein the RF contact includes:
a buried section configured to be embedded in the bottom while being spaced apart from the front surface of the first island by a predetermined distance along the first axis direction,
a first movable section configured to extend from one end of the buried section along a third axis direction perpendicular to the first axis and the second axis to allow elastic deformation by an external force, and
a second movable section configured to extend from the other end of the buried section along the third axis direction to allow elastic deformation by the external force,
wherein the RF contact is configured to form double contact points with an RF contact of a counterpart connector through the first movable section and the second movable section.

12. The connector of claim 11, wherein the buried section includes:
a first buried section configured to be embedded in the bottom and to be exposed to the outside through a lower surface of the insulating body, and
a second buried section configured to extend from the first buried section to connect the first buried section with the first movable section and the second movable section with one another while being embedded in the bottom.

13. The connector of claim 1, wherein the signal contact includes:
a first signal contact configured to be fixed to the second island to surround its surface and be exposed to the outside, and
a second signal contact configured to be fixed to the third island to surround its surface and be exposed to the outside.

14. The connector of claim 1, wherein the insulating body includes:
a rim area form along a rim of the bottom, configured to be spaced apart from the three islands and to surround all three islands, and
a cutout area configured to be cut out in the rim area to be located at a position corresponding to the signal contact.

15. A connector comprising:
an insulating body including three bar-shaped islands each configured to have a predetermined length along a first axis direction as a longitudinal direction and to protrude from a bottom at a predetermined height, the three bar-shaped islands being spaced apart from one another along a second axis direction perpendicular to the first axis;
a shield configured to be made of a conductive material, and coupled to a rim area along a rim of the insulating body; and
a contact configured to be coupled to the insulating body to be electrically connected to an outside,
wherein the three bar-shaped islands include a first island, and a second island and a third island disposed on both sides of the first island along the second axis direction as a width direction,
wherein the contact includes an RF contact for transmitting an RF signal, a signal contact for transmitting a general signal, and a shield contact for electrical shielding,
wherein the first island is configured to have a relatively shorter length than the second island and the third island along the first axis direction so as to be disposed at one end side of the first island while the RF contact is disposed between a side surface of the second island and a side surface of the third island facing each other.

16. The connector of claim 15, wherein the shield contact includes:
a first section configured to cover the upper surface, the front surface, and the side surface of the second island or the upper surface, the rear surface, and the side surface of the third island,
a second section configured to cover the upper surface, the rear surface, and the side surface of the second island or the upper surface, the front surface, and the side surface of the third island, and
a third section configured to cover a front surface or a rear surface of the first island,
wherein the RF contact is disposed to be surrounded by the first section, the second section, and the third section.

17. The connector of claim 15, wherein the first section, the second section, and the third section each include a portion forming a contact point with a shield contact of a counterpart connector.

18. The connector of claim 16, wherein the first section includes:
an upper section configured to cover the upper surface of the second island or the upper surface of the third island,
a first extension section configured to extend from the upper section to cover an outer side surface of the second island or an outer side surface of the third island,
a second extension section configured to extend from the upper section to cover the front surface of the second island or the rear surface of the third island,
a first contact section configured to extend from the upper section to cover an inner side surface of the second island while forming a contact point with a shield contact of a counterpart connector, or to cover an inner side surface of the third island while forming a contact point with a shield contact of a counterpart connector, and
a mounting section configured to extend from an end of the first extension section to be exposed to a lower surface of the bottom.

19. The connector of claim 16, wherein the second section includes:
an upper section configured to cover the upper surface of the second island or the upper surface of the third island,
a third extension section configured to extend from the upper section to cover an outer side surface of the second island or an outer side surface of the third island,
a fourth extension section configured to extend from the upper section to cover the rear surface of the second island or the front surface of the third island,
a second contact section configured to extend from the upper section to cover an inner side surface of the second island while forming a contact point with a shield contact of a counterpart connector, or to cover an inner side surface of the third island while forming a contact point with a shield contact of a counterpart connector, and
a mounting section configured to extend from an end of the third extension section to be exposed to a lower surface of the bottom.

20. The connector of claim 16, wherein the third section includes:
a third contact section configured to extend from the first section or the second section along a height direction of the first island to cover the front surface of the first island or the rear surface of the first island while forming a contact point with a shield contact of a counterpart connector, and
a fixing section configured to be bent from an end of the third contact section to be embedded in the first island.
